(19) United States
(12) Patent Application Publication
(10) Pub. No.: US 2008/0030482 A1
(43) Pub. Date: Feb. 7, 2008

(54) Force-based input device having an elevated contacting surface

(76) Inventors: James K. Elwell, Salt Lake City, UT (US); James R. Mullins, Centerville, UT (US); David A. Soss, Salt Lake City, UT (US); Karen Stanley, Eagle Mountain, UT (US)

Correspondence Address: THORPE NORTH & WESTERN, LLP., 8180 SOUTH 700 EAST, SUITE 350, SANDY, UT, 84070, US

(21) Appl. No.: 11/888,673

(22) Filed: Jul. 31, 2007

Related U.S. Application Data
(60) Provisional application No. 60/834,663, filed on Jul. 31, 2006.

(51) Int. Cl. G06F 3/041

(52) U.S. Cl. 345/173

(57) ABSTRACT

A projected force-based input device comprising a projected or elevated contacting element configured to receive an applied force, a sensing element located in a different plane with respect to the contacting element, and a sensing portion operably supported to displace in response to the applied force. The sensing element further comprises a plurality of sensors operable to output sensor data corresponding to the applied force, wherein the sensor data facilitates the determination of a location of the applied force occurring about the contacting element, as well as the profile of the applied force over time (e.g., waveform), otherwise known as the force profile. One or more transfer elements may also be present, which function to relate the contacting element to the sensing portion of the sensing element so as to transfer substantially all of the applied force from the contacting element to the sensing element. Adequate rigidity between the elevated contacting element, and transfer elements, and the sensing element is intended to be maintained in order to prevent interference with any mounting or other structures or objects, and to permit the input device to operate properly.

### RELATED APPLICATIONS

This application claims the benefit of U.S. Provisional Patent Application No. 60/834,663, filed Jul. 31, 2006, and entitled, “Projected Force-based Input Device,” which is incorporated by reference in its entirety herein.

### FIELD OF THE INVENTION

The present invention relates generally to input devices, such as touch panels, touch screens, etc., and more particularly to force-based input devices of the same.

### BACKGROUND OF THE INVENTION AND RELATED ART

Input devices (e.g., touch screens or touch pads) are designed to detect the application of an object and to determine one or more specific characteristics of or relating to the object as relating to the input device, such as the location of the object acting on the input device, the magnitude of force transmitted to the input device as induced by the object, the profile of an applied force over time (e.g., waveform), and/or a combination of these, etc. Examples of some of the different applications in which input devices are commonly found include computer display devices, kiosks, games, point of sale terminals, vending machines, medical devices, keypads, keyboards, and others.

Currently, there are a variety of different types of input devices available on the market. Some examples include resistive-based input devices, capacitance-based input devices, surface acoustic wave-based devices, force-based input devices, infrared-based devices, and others. While providing some useful functional aspects, each of these prior related types of input devices, as currently configured, suffer in one or more areas.

Resistive-based input devices typically comprise two conductive plates that are required to be pressed together until contact is made between them. Resistive sensors only allow transmission of about 75% of the light from the input pad, and lowering the display contrast, thereby making it difficult to use such devices in high-brightness applications. In addition, the front layer of such devices is typically comprised of a soft material, such as polyester, that can be easily damaged by hard or sharp objects, such as car keys, pens, etc. As such, this makes them inappropriate for most public-access applications.

Capacitance-based input devices operate by measuring the capacitance of the object applying the force to ground, or by measuring the alteration of the transcapacitance between different sensors. Capacitance-based sensors typically are only capable of detecting large objects as these provide a sufficient capacitance to ground ratio. In other words, capacitance-based sensors typically are only capable of registering or detecting application of an object having suitable conductive properties, thereby eliminating a wide variety of potential useful applications, such as the ability to detect styli and other similar touch or force application objects. In addition, capacitance-based sensors allow transmission of about 90% of input pad light.

Surface acoustic wave-based input devices operate by emitting sound along the surface of the input pad and measuring the interaction of the application of the object with the sound. In addition, surface acoustic wave-based input devices allow transmission of nearly 100% of input pad light, and don't require the applied object to comprise conductive properties. However, surface acoustic wave-based input devices are incapable of registering or detecting the application of hard and small objects, such as pen tips, and they are usually the most expensive of all the types of input devices. In addition, their accuracy and functionality is affected by surface contamination, such as water droplets.

Infrared-based devices are operated by infrared radiation emitted about the surface of the input pad of the device. However, these are sensitive to debris, such as dirt, as well as sun or other light, all of which affect their accuracy.

Force-based input devices are configured to measure the location and magnitude of the forces applied to and transmitted by the input pad. Force-based input devices provide some advantages over the other types of input devices. For instance, they are typically very rugged and durable, meaning they are not easily damaged from drops or impact collisions. Indeed, the input pad (e.g., touch screen) can be a thick piece of transparent material, resistant to breakage, scratching and so forth. There are no interposed layers in the input pad that absorb, diffuse or reflect light, thus nearly 100% of available input pad light can be transmitted. They are typically impervious to the accumulation of dirt, dust, oil, moisture or other foreign debris on the input pad.

Force-based input devices typically comprise one or more force sensors that are configured to measure the applied force. The force-based input device can be operated with gloved fingers, bare fingers, styli, pens pencils or any object that can apply a force to the input pad. Despite their advantages, existing force-based input devices are typically too large and bulky to be used effectively in many touch screen applications. Additionally, conventional force-based input devices, as well as most other types of input devices, are capable of registering touch from only one direction, or in other words, on one side of the input pad, thereby limiting the force-based input device to monitor or screen-type applications.

One particular problem associated with force-based input devices deals with off-axis forces, which may be described as forces that are parallel to the touch surface or input portion. These are undesirable and tend to skew any results. Examples of means used to deal with and minimize these off-axis forces are ball joints, pointed supports, and springs. However, these are difficult and costly to make, and still do not work particularly well.

Another issue facing force-based input devices is constraint or over constraint of the input member as it is often necessary to resolve the both the direction and location of application of the force.

Still another issue is vibration, which causes a problem because of the typical mass of the input member (e.g., the touch screen). Forces may be transmitted from the support to the input member when the support experiences vibration, which may cause inaccurate measurements and readings. Associated with this is inertia, wherein the baseline outputs of the sensors may depend on the orientation of the input member. The mass of the input member may produce different forces depending on its orientation. These different forces have been difficult to account for.

In addition to the problems discussed above, current force-based input devices require the sensors to be located on or within the actual contacting element configured to receive the applied force. As such, the potential applications in which such current force-based input devices may be used are limited.

### SUMMARY OF THE INVENTION

In accordance with the invention as embodied and broadly described herein, the present invention features a projected force-based input device comprising a projected or elevated contacting element configured to receive an applied force, a sensing element located in a different plane with respect to the contacting element, and a sensing portion operably supported to displace in response to the applied force. The sensing element further comprises a plurality of sensors operable to output sensor data corresponding to the applied force, wherein the sensor data facilitates the determination of a location of the applied force occurring about the contacting element, as well as the profile of the applied force over time (e.g., waveform), otherwise known as the force profile. One or more transfer elements may also be present, which function to relate the contacting element to the sensing portion of the sensing element so as to transfer substantially all of the applied force from the contacting element to the sensing element. Adequate rigidity between the elevated contacting element, and transfer elements, and the sensing element is intended to be maintained in order to prevent interference with any mounting or other structures or objects, and to permit the input device to operate properly.

The present invention resides in a projected force-based input device comprising a sensing element having a mounting portion and a sensing portion operable to detect and measure an applied force; a plurality of force sensors operable within the sensing portion to measure a resultant characteristic of the applied force, and to output sensor data corresponding to the resultant characteristic; a contacting element elevated at least partially from the sensing element and having a contacting surface operable to initially receive the applied force; means for projecting substantially all of the applied force from the contacting element to the sensing portion of the sensing element to cause the resultant characteristic be detected and measured by the sensors as if the applied force were acting directly on the sensing element; and processing means operable to receive and process the sensor data, and to determine a location and profile of the applied force as acting on the contacting surface of the contacting element.

The present invention also resides in a projected force-based input device comprising a contact plane having a contact surface for receiving an applied force; a sensing plane offset from the contact plane, and comprising a sensing element having a sensing portion; a plurality of sensors operable within the sensing portion to output sensor data corresponding to the applied force, wherein the sensor data facilitates the determination of a location and profile of the applied force as occurring about the contact plane; and at least one force transfer element that transfers substantially all of the applied force occurring about the contact plane to the sensing portion of the sensing plane.

The present invention further resides in a projected force-based input device comprising a contacting element contained within a contact plane, and having a contacting surface configured to receive an applied force; a sensing element contained within a sensing plane, and having a plurality of sensors operable therewith to output sensor data corresponding to the applied force, wherein the sensor data facilitates the determination of a location and profile of the applied force about the contacting element; and a transfer element configured to project the contacting plane away from the sensing plane, and to transfer substantially all of the applied force from the contacting element to the sensing element.

The projected force-based input devices of the present invention are capable of identifying or determining the precise location and profile of a force applied to the contact surface of the contacting element. The method for determining the location and profile of the applied force more or less complex depending upon the different possible design configurations of input devices. If the location is outside the perimeter of the sensing element, the sign of the force received by the sensors is simply reversed. This sign reversal indicates to the calculating algorithms of this fact of being outside the perimeter of the sensing element. As such, the present invention still further resides in, within a projected force-based input device, a method for determining a location and profile of an applied force and for performing one or more operations, the method comprising receiving an applied force about a contacting surface of an elevated contacting element; transferring the applied force to a sensing portion of a sensing element supported in a different elevation with respect to the contacting element, the sensing element having a plurality of sensors operable to output sensor data corresponding to the applied force; measuring a characteristic of the applied force; generating sensor data based on the measured characteristic; and processing the sensor data to determine a location and profile of the applied force occurring about the contacting element.

The present invention still further resides in a method for constructing a projected force-based input device, the method comprising providing a sensing element having a mounting portion and a sensing portion operable to detect an applied force; securing the mounting portion of the sensing element; supporting the sensing portion of the sensing element so as to be movable with respect to the mounting portion; providing a plurality of force sensors operable within the sensing portion to measure a resultant characteristic of the applied force, and to output sensor data corresponding to the resultant characteristic; positioning a contacting element in a different elevation with respect to the sensing element, the contacting element having a contacting surface operable to initially receive the applied force; relating the sensing element to the contacting element with sufficient rigidity so as to effectuate transfer of substantially all of the applied force from the contacting element to the sensing element, the contacting element projecting substantially all of the applied force to the sensing portion of the sensing element to cause the resultant characteristic be detected and measured by the sensors as if the applied force were occurring directly about the sensing element; and providing processing means operable to receive and process the sensor data, and to determine a location and profile of the applied force as acting on the contacting surface of the contacting element.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of a projected force-based input device in accordance with one exemplary embodiment of the present invention;

FIG. 2 illustrates a graphical diagram of an exemplary projected force-based input device;

FIG. 3 illustrates a force-based sensing device in accordance with one exemplary embodiment;

FIG. 4 illustrates a perspective view of the force-based sensing device of FIG. 3 as coupled to a processing system used to perform the necessary processing steps to determine the location and profile of the applied force;

FIG. 5 illustrates a detailed view of a portion of the exemplary force-based sensing device of FIG. 3;

FIG. 6 illustrates a force-based sensing device in accordance with another exemplary embodiment of the present invention;

FIG. 7-A illustrates a front view of a projected force-based input device in accordance with another exemplary embodiment of the present invention;

FIG. 7-B illustrates a side view of the projected force-based input device of FIG. 7-A;

FIG. 8 illustrates a front view of a projected force-based input device in accordance with another exemplary embodiment of the present invention, in which the projected contacting element comprises an arbitrary shape, of which a portion extends beyond the sensing element;

FIG. 9-A illustrates a front view of a projected force-based input device in accordance with another exemplary embodiment of the present invention, in which the projected contacting element comprises different elevations or planes;

FIG. 9-B illustrates a side view of the projected force-based input device of FIG. 9-A;

FIG. 10-A illustrates a front view of a projected force-based input device in accordance with another exemplary embodiment of the present invention, in which the apertures form isolated beam segments oriented on an incline with respect to the perimeter of the sensing element;

FIG. 10-B illustrates a side view of the projected force-based input device of FIG. 10-A;

FIG. 11-A illustrates a front view of a projected force-based input device in accordance with another exemplary embodiment of the present invention, in which the projected input device comprises a floating configuration;

FIG. 11-B illustrates a side view of the projected force-based input device of FIG. 11-A;

FIG. 12-A illustrates a front view of a projected force-based input device in accordance with another exemplary embodiment of the present invention, in which a protruded portion formed with the sensing element functions to support the contacting element in a projected position;

FIG. 12-B illustrates a side view of the projected force-based input device of FIG. 12-A;

FIG. 13 illustrates a side view of a projected force-based input device in accordance with another exemplary embodiment of the present invention, in which the projected contacting element passes through a partition, and wherein the partition and transfer elements are sealed;

FIG. 14 illustrates a partial perspective view of a projected force-based input device in accordance with still another embodiment of the present invention, wherein the force transfer elements comprise springs having a given spring constant or stiffness;

FIG. 15-A illustrates a top view of a projected force-based input device in accordance with still another exemplary embodiment of the present invention, wherein multiple projected or elevated contacting elements are supported about and operable with a single sensing element;

FIG. 15-B illustrates a side view of the exemplary projected force-based input device of FIG. 15-A;

FIG. 16 illustrates a side view of a projected force-based input device in accordance with still another exemplary embodiment of the present invention, wherein the contacting element is in direct contact with the sensing element, thus eliminating the need for force transfer elements;

FIG. 17 illustrates a side view of a projected force-based input device in accordance with still another exemplary embodiment of the present invention, wherein the sensing element comprises a cut-out portion, and the contacting element is configured to receive an applied force about a surface proximate the sensing element, through the cut-out portion;

FIG. 18 illustrates a side view of a projected force-based input device in accordance with still another exemplary embodiment of the present invention, wherein the force transfer element is oriented on an incline with respect to the contacting and sensing elements;

FIG. 19-A illustrates a top view of a projected force-based input device in accordance with still another exemplary embodiment of the present invention, wherein the sensing element comprises a non-planar, multi-elevational configuration;

FIG. 19-B illustrates a side view of the exemplary input device of FIG. 19-A; and

FIG. 20 illustrates a front view of an exemplary user interface layout operable with a projected force-based input device in accordance with the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Generally speaking, the present invention describes a force-based input device having a projected or elevated contacting element/surface and a sensing element, these being offset from or located in a different plane with respect to one another. Providing a sensing element having a projected or elevated contacting element mounted thereto functions to project onto the sensing element one or more forces acting about the contacting element, which forces are sensed at the projected location. Proper operation and accuracy depends upon a sufficiently rigid structure or assembly between the sensing element, any mounting devices and the projected contacting element.

The present invention further describes a method for determining a touch or impact about the elevated contact surface occurring as an applied force that originates at one or more points or locations of contact, wherein the applied force is transferred to the sensing element and a corresponding characteristic of the applied force measured by one or more sensors operable with the sensing element. The sensors are configured to output a signal corresponding to the measured force to a processor, which is configured to receive and process the signal to determine the exact location and profile of the contact occurring on the contacting element. The force applied about the contacting element and measured by the sensing element and sensors may be a single applied force, multiple applied forces applied systematically or randomly and simultaneously or in succession, or a continuously applied force.

The present invention input device operates using force sensors located at or near the corners of the sensing element. The sensors detect applied forces on the contacting element and transferred to the sensing element, and output signals to processing means for determining the location and profile of the applied forces. To operate accurately, the sensing element should be sufficiently rigid so as to disperse the resulting force induced by the applied force to the sensors proportionally to the location of the touch. Mounting the contacting element to the sensing element allows the force of a touch on the contacting element to be transmitted to the sensing element. If the contacting element, any force transfers and the sensing element form an adequately rigid assembly, an applied force on the contacting element will be sensed in the same x-y location as an applied force directly on the sensing element. Off-axis (transverse) force components of an applied force will be amplified by the projected configuration. The more offset the contacting element is from the sensing element in ratio with the x-y spacing of the force sensors, the greater the off-axis force amplification.

It is intended, although not necessary, that force sensors be used that can detect both positive and negative normal (z-axis) forces being applied to the contacting element. In this case, the elevated contacting element is not constrained to be within the x-y dimensions of the sensor locations. An applied force on the elevated or projected contacting element outside of the sensor location boundary will produce a negative z-axis force on some sensors, and a positive z-axis force on the others. Appropriate calculations will yield the true location and profile of the applied force, even when it is outside the x-y dimensions of the sensor locations or boundary. The distance which the projected contacting element may extend beyond the x-y sensor boundary will depend on the range of force over which the sensors can accurately measure the force of an applied force. A very long distance will produce a lever effect where a touch of X Newtons will produce a force on some of the sensors that is a multiple of X Newtons.

Each of the above concepts is discussed in greater detail below.

The present invention provides several significant advantages over prior related force-based input devices, some of which are recited throughout the following more detailed description. For example, with a projected or elevated contacting element, many useful applications become available that were not otherwise possible. In addition, a variety of unique and unconventional aesthetics or user interfaces are possible that were not otherwise possible with prior related input devices. Each of the advantages recited herein are not meant to be limiting in any way. Indeed, one skilled in the art will appreciate that other advantages may be realized upon practicing the present invention.

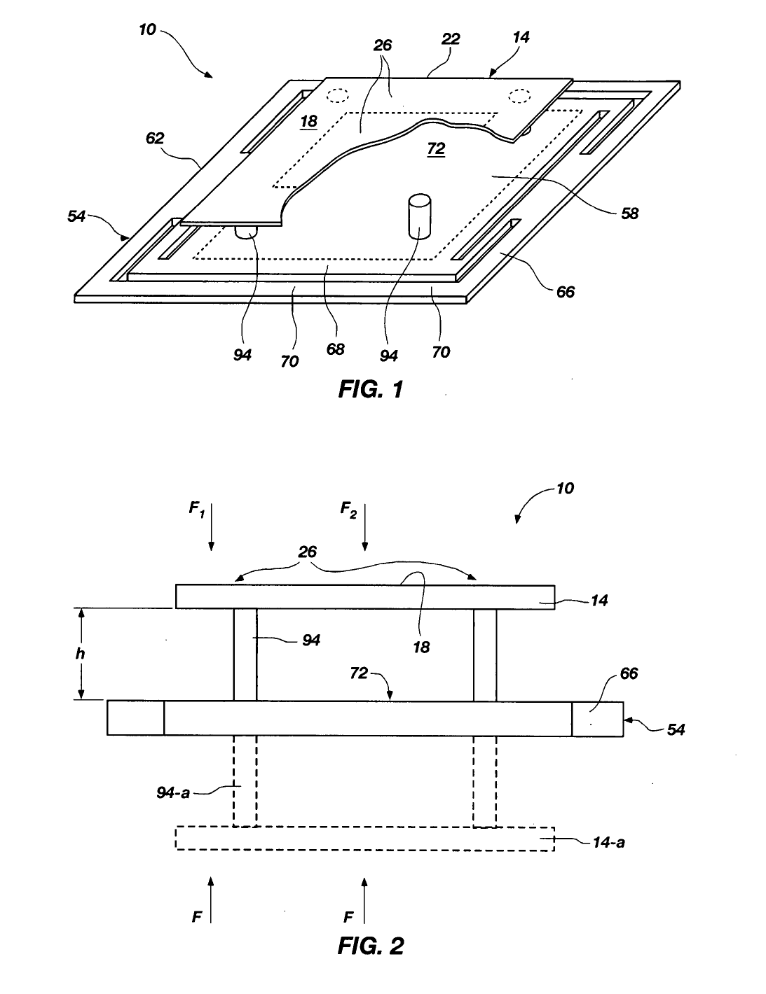

With reference to FIGS. 1 and 2, illustrated is a general projected force-based input device in accordance with one exemplary embodiment of the present invention. As shown, the projected force-based input device 10 comprises a contacting element 14 projected or elevated outward or away from a sensing element 54, wherein the contacting element 14 is supported by one or more force transfer elements (hereinafter “transfer elements”), shown as transfer elements 94. Stated differently, the contacting element 14 lies in one or more contact planes that are different from the one or more sensing planes in which the sensing element 54 lies. As will be explained below, the contacting plane is configured and intended to be different than the sensing plane, thus enabling a contacting element 14 to be located in a projected or elevated position away from the sensing element 54. Although providing a projected or elevated contacting element 14, the entire input device 10 is configured to function as a monolithic structure, meaning that a touch on the elevated or projected contacting element is measured by the sensing element as if applied directly to the sensing element along the same axis extending through the surfaces of the respective contacting and sensing elements. Accuracy in the determination of the location and profile of the applied force about the elevated or projected contacting element is primarily dependant upon the relative lateral movement between the contacting element and the sensing element. In addition, the various components of the input device are designed to comprise sufficient rigidity so that no contact by any of the components of the input device come in contact with any mounting structures supporting the input device, or that torsion, if any, in the sensing element is kept within acceptable limits. These parameters will dictate most designs. Stated differently, the input device, and particularly one or more of the components of the input device, may be rigid, semi-rigid or somewhat flexible, with the degree of flexibility being limited by the above parameters. By acting like a monolithic structure, the input device 10 functions as if it constitutes an undifferentiated whole, or as comprising workable uniformity. If the input device is sufficiently rigid, bending moments or torques created by the non-normal force of an applied force will not have any substantial effect on the operation of the input device. Where moments or torques are generated, if they are small enough relative to the resolution required, they will not effect operation and will not have to be accounted for in processing the various output signals.

### Contacting Element

The contacting element 14 functions as the interface between a user or object and the projected force-based input device 10, and is intended to comprise a separate and independent structure from the sensing element 54. More specifically, the contacting element 14, as projected or elevated, is configured and intended to receive an applied force about its surface 18 from one or more objects, such as bare fingers, gloved fingers, styli, pens pencils or any other object capable of applying or causing to be applied or facilitating application of a force to the contact surface 18.

As a force is being applied to the contacting surface 18, and once an applied force is received, the contacting element 14 functions to transfer or convey all or substantially all, and in any event a proportional amount, of the applied force to the one or more transfer elements 94, which in turn function to transfer or convey all or substantially all of the force to the sensing element 54. In order to transmit or convey the applied force occurring about the contacting surface 18 to the transfer elements 94, the contacting element 14 itself, or at least a portion thereof, is intended to be sufficiently rigid, thus minimizing or eliminating the potential for contact by the contacting element 14 with a mounting or other fixed structure that would interfere with the receipt and transfer of the applied force. One way for the entire applied force on the contacting element not to be transmitted or transferred to the sensing element is if there is interference with some object or structure, such as the mounting structure used to mount the input device. Even if the input device is not entirely rigid, the force transfer is intended to be total, obviously unless there is some type of mechanical interference.

In the exemplary embodiment shown, the contacting element 14 comprises a solid top or plate-like member having a perimeter 22 circumscribing a contact surface 18 configured to receive an applied force, such as one originating at one more points or locations of contact. The contacting element 14 may comprise any configuration, including, but not limited to, any thickness, size, surface contour, etc. In addition, the contacting element 14 may be configured with different aesthetic looks or designs.

Although shown this way in this particular drawing, the contacting element 14 is not required to be a single, solid or unitary structure. Indeed, it is contemplated that the contacting element may comprise several structural elements, which may or may not be coupled together or even directly or indirectly connected, and each of which are supported in a projected manner about the sensing element 54. In addition, the contacting element 14 may comprise one or more holes, apertures, recesses, etc. In any event, the contacting element is intended to comprise sufficient rigidity so as to enable the input device to properly function. For instance, in one aspect, the contacting element 14 may comprise a lattice-work or grid of structural elements that make up a contacting surface. In another aspect, the contacting element 14 may comprise a plurality of primary solid structural elements linked or coupled together by a plurality of intermediate or secondary structural elements, each of which are sufficiently rigid. In still another aspect, several independent contacting elements may be operably supported in a single projected force-based input device, each one being operable with the same or different sensing elements.

Moreover, the contacting element 14 may comprise removable and/or interchangeable components, thus allowing the contacting element 14 to comprise different sizes, shapes, aesthetics, etc., as needed or desired. Again, these, or at least the transfer elements and/or sensing elements are intended to be sufficiently rigid to permit proper operation of the input device. Again, it is noted that accuracy in determining the location and profile of the input or applied force acting on the one or more contacting elements is dependent upon the relative lateral movement between the contacting element, no matter the number or if coupled together or not, which lateral movement is preferably kept to a minimum.

In one exemplary embodiment, based on the configuration and intended function of the projected force-based input device 10, the applied force about the contacting surface 18 of the contacting element 14 may originate with and comprise a single contact, such as a single touch, originating at a single location or point. It is this single contact whose location and/or magnitude is to be determined. Once determined, the projected force-based input device 10 is configured to carry out one or more functions, such as signal output, signal processing, and user feedback, based on the input corresponding to the specific location of contact about the contacting element 14. The same is true for multiple contacts or touches.

In the particular embodiment shown in FIG. 1, the contacting element 14 is sized and configured so that its surface area is smaller than that of the sensing element 54, or in other words, so that its perimeter does not extend beyond that of the sensing element 54. The contacting element 14 is shown as comprising a square shape and a flat, planar contacting surface 18. As will be apparent from the description herein, the contacting element 14 may comprise any geometric configuration characterized by points, lines, curves, and any combination of these. Indeed, any shape is possible, such as an arbitrary shape, a polygon, any curved shape, or any combination of these. Moreover, the contacting element may comprise various surface contours or topographies, and may thus have a contacting surface that resides in multiple planes. In addition, many different sized contacting elements are contemplated. As will be apparent to those skilled in the art, each of these will largely depend upon various design constraints, as well as the particular application in which the projected force-based input device is to be used.

The area designed to receive the applied force may be the entire upper contacting surface 18. Alternatively, the contacting element 14 may optionally comprise a designated or delineated input area 26, as shown by the phantom lines about the contact surface 18.

The contacting element 14 may be comprised of any material capable of receiving and transferring an applied force. As such, the contacting element 14 is intended to be constructed of a material sufficiently rigid so as to transmit the applied force received about its contacting surface 18 to the transfer elements 94. Various materials, such as metal, ceramic, plastic, glass, stone, marble, wood, etc., and combinations of these, are contemplated for use. The contacting element 14 may be operable with one or more flexible materials, such as cloth, fabric, foam, rubber, etc., supported about all or a portion of the contacting surface 18.

The material from which the contacting element 14 is constructed is not constrained to a single, homogenous material. Indeed, the contacting element 14 may be comprised of a combination of materials. For example, the contacting element can be made of aluminum having an aperture formed therein configured to receive and support a transparent component, such as glass or an acrylic component, with both of the aluminum and glass or acrylic making up the contacting element and providing a contacting surface.

### Force Transfer Element

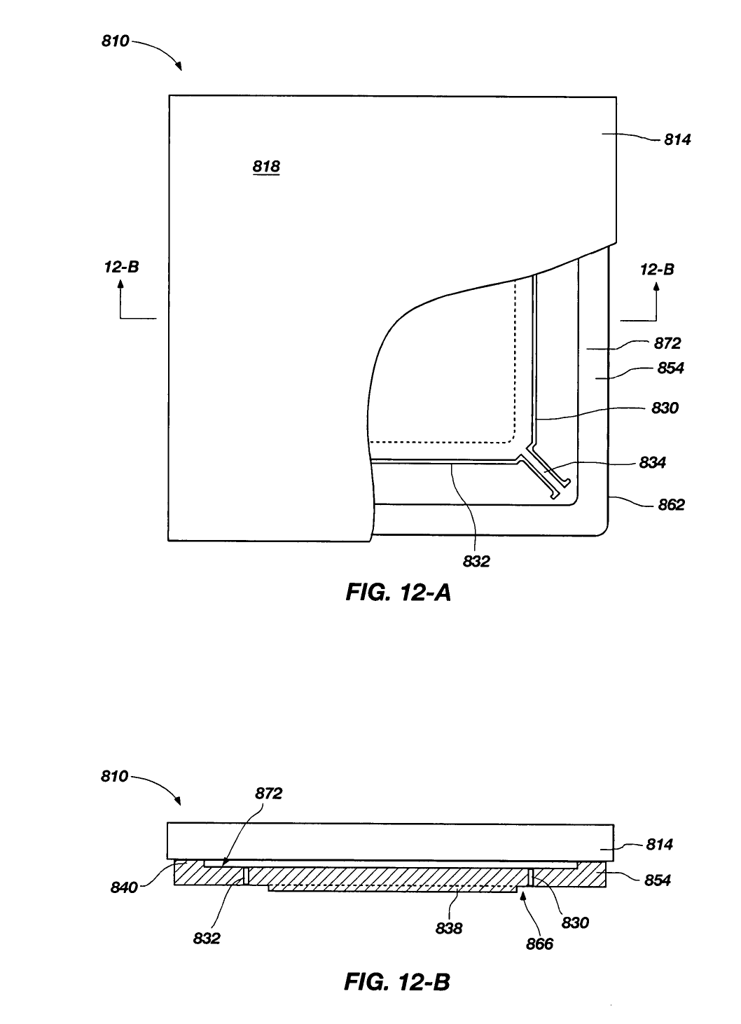

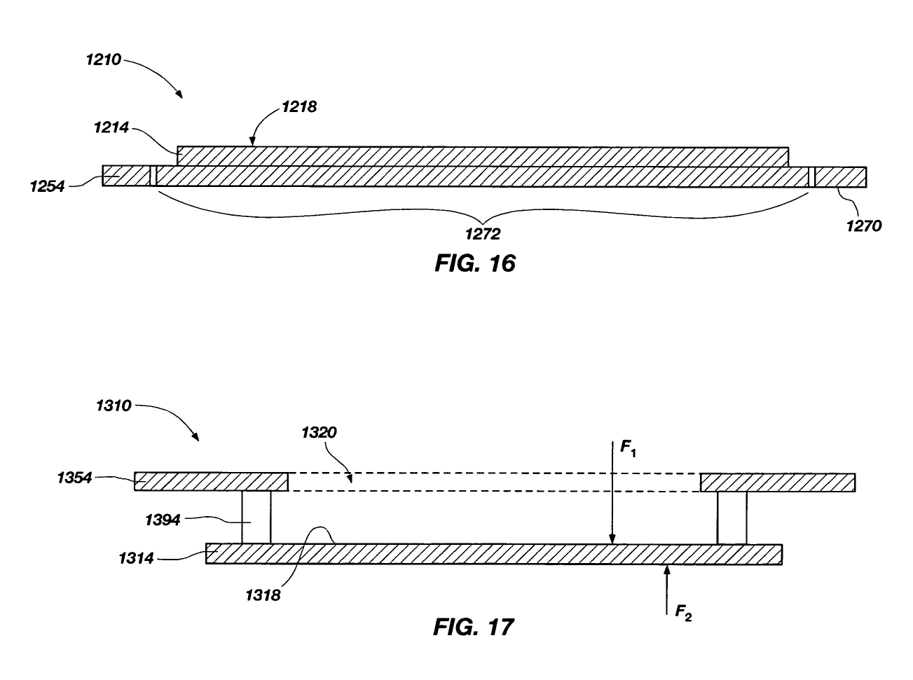

The present invention comprises means for projecting substantially all of the applied force from the contacting element to the sensing portion of the sensing element to cause a resultant characteristic to be detected and measured by the force sensors as if the applied force were acting directly on the sensing element. Means for projecting may involve an independent force transfer element (see FIGS. 1-5), a protrusion formed with and extending upward from the sensing portion (see FIGS. 12-A and 12-B), a protrusion formed with and extending down from the contacting element, a direct contacting relationship between the sensing and contacting elements (see FIG. 16) or any combination of these. Perhaps the most common is an individual force transfer element that mounts to both the sensing and contacting elements.

Transfer element 94, in which the exemplary projected force-based input device 10 illustrated in FIG. 1 comprises four of, functions to operably relate the projected contacting element 14 to the sensing element 54, meaning that the sensing element 54, although not directly receiving an applied force, is caused to measure a characteristic of the applied force acting on or about the contacting element 14 as if the force were acting directly on the sensing element 54. Stated differently, the transfer element 94 is coupled to both the projected contacting element 14 and the sensing element 54 in a manner so as to transfer or convey all or substantially all of the force applied to or acting on the surface 18 of the contacting element 14 to the sensing element 54, wherein the applied force may be sensed. Any discrepancies in the sensed force as a result of being transferred to the sensing element 54, as compared to a configuration where the force is otherwise not transferred and the contacting element functions also as the sensing element, may be accounted for, identified, and figured into the calculations performed by the processing means in determining the location, profile and/or magnitude of the applied force. However, it is intended that such force degradation be equal, or evenly distributed amongst the various transfer elements, and thus less of an issue. It is intended that the transfer elements transfer either all of the force, or proportionally scale it down equally for each transfer element so that the ratio of forces between the transfer elements is not changed.

From a structural standpoint, the transfer element(s) 94 are configured provide support to the contacting element 14 to enable the contacting element 14 to be operably located in a different or projected plane with respect to the sensing element 54. In this capacity, the transfer elements act much like spacers. In addition, the transfer elements may be configured to comprise any different size and/or shape, much of which will depend upon the particular application in which the projected force-based input device is intended, the ability of the processing means to account for the material makeup and performance properties of the transfer elements during use, and/or the number of transfer elements used to support the contacting element in a projected position. As shown, the transfer elements 94 comprise solid, elongate cylindrical members sized to position the contacting element a distance h from the contact surface 58 of the sensing element 54. This distance or height may vary as needed, and is not limited to any particular measurement.

In one aspect, the transfer elements 94 may comprise any rigid structure, such as steel bolts, screws, etc. In another aspect, the transfer elements 94 may comprise a semi-rigid or semi-flexible structure, such as a spring. Again, they should be sufficiently rigid so as to not permit the contacting element or the sensing element to come in contact with any mounting or other structures. Spacers or washers may further be combined with the transfer elements.

The transfer elements may be configured to attach or mount to a surface of the contacting and sensing elements, or they may be configured to penetrate or extend through these and be attached. The transfer elements may be held at a specific distance from the contacting and sensing elements using unthreaded or threaded spacers, or threaded nuts. Where the sensing and/or contacting elements comprise threaded holes, the transfer elements may be bolts that are threaded into the holes and secured with a nut on the opposite side. Where the sensing and/or contacting elements have unthreaded holes, nuts on either side may be used to secure the transfer element (in the form of a bolt) into position. As can be seen, the transfer elements may be mounted using commonly known fastening means. In most cases, the transfer elements will be located or positioned around the periphery of the smaller of the sensing or contacting elements.

Depending upon the projected distance of the contacting element with respect to the sensing element, and the intended application of the input device, adhesives may be used to attach the transfer elements to both the sensing and contacting elements.

The nature and design of the transfer elements may be dictated by aesthetics (such as in the case where they will be visible), by functionality (providing adequate rigidity to the assembly), by other system constraints (e.g., providing lighting to a projected panel), and/or by other considerations, such as how the material making up the transfer elements is best secured.

The transfer elements may also comprise one or more solid or hollow elements constructed from sheet metal, machined or molded plastic, or other material suitable to the design and aesthetics of the input device. In one exemplary embodiment, the transfer elements may comprise a sheet metal box constructed so as to be attached or coupled to the sensing element using a threaded fastener (e.g., a bolt and nut assembly), and attached or coupled to the projected contacting element using an adhesive. The sheet metal provides various advantages, such as providing good surface area on which adhesives may be applied and used, and facilitating the use of lights between the contacting and sensing elements.

The transfer elements may comprise a machined element, such as a block of aluminum or rigid plastic, machined to accommodate fasteners (e.g., screws, bolts, etc.) and/or adhesives between the transfer element and either the contacting or sensing elements. Other features may be machined into such transfer elements, such as a hole to allow wiring for one or more purposes to be routed where it would not be visible.

Other materials for the transfer elements may include the same material as being used for the projected contacting element (e.g., granite), which contributes to the overall aesthetics of the input device.

The size, geometry, and material makeup of the transfer elements will greatly affect or influence their ability to properly transfer the applied force from the contacting element to the sensing element to ensure an accurate determination of the location, profile and/or magnitude of the applied force on the contacting element 14. As indicated, processing means may be configured to identify and account for the performance properties of any type of transfer element used.

Functionally speaking, the transfer element(s) 94 are again configured to operably relate the contacting and sensing elements, and namely to transfer all or at least a sufficient amount of any applied force acting on the contacting element 14 to the sensing element 54 so that the applied force, or a characteristic or corresponding attribute thereof, may be sensed by the sensing element 54 for the purpose of outputting sensor data that may be used to determine the location, profile and/or magnitude of the applied force. As stated, the transfer elements 94 are intended to transfer or facilitate a transfer of any forces received therein from the contacting element 14 to the sensing element 54. Stated differently, whatever the magnitude of force being applied to the contacting element 14, the same, or as much as possible, is intended to be indirectly applied to the sensing element 54 through the transfer elements 94. Therefore, the transfer elements may be configured to proportionally scale down the force equally across each of the transfer elements.

As indicated, the transfer elements 94 may comprise any suitable or operable configuration, size and/or shape, each of which, however, may be constrained by one or more operating parameters, such as the distance all or a portion of the projected contacting element 14 is desired or required to be spaced from the sensing element 54. In one aspect, the transfer element 94 may comprise an independent, rigid member, such as the several rigid rod-like members shown in FIGS. 1 and 2, that extend between the projected contacting element 14 and the sensing element 54 a pre-determined or specific distance. In another aspect, the transfer element may comprise one or more protrusions formed and integral with the contacting element, the sensing element or both.

Although the illustrated exemplary force-based input device 10 comprises four transfer elements, a single projected force-based input device may comprise any number of transfer elements, as well as any number of projected or elevated contacting and sensing elements. Indeed, a projected force-based input device may comprise a plurality of transfer elements strategically positioned, some of which may be of a different size, shape, material makeup and/or configuration. For example, as will be discussed below, the contacting element and/or the sensing element may exist in multiple planes, at multiple elevations, etc. As such, the various transfer elements used may be of a different length to compensate for the different elevation changes or other characteristics of the contacting element and to properly support the contacting element or contacting elements in a projected manner about the sensing element or sensing elements.

### Sensing Element

The sensing element 54, as located in a sensing plane different from the contacting plane, comprises any force-based sensing device capable of detecting an applied force occurring on the contacting element 14, as transferred thereto via the transfer element 94, and measuring one or more characteristics or corresponding attributes of the applied force.

The sensing element 54 is operably related to the contacting element 14 such that all or substantially all of the applied force acting or occurring on the contacting element 14 is transferred to the sensing element 54, through the transfer element(s) 94, wherein the sensing element 54 functions to detect and measure the applied force, or a characteristic or corresponding attribute pertaining thereto, thus facilitating the determination of the location and profile of the applied force about the contacting element 14. Specifically, the sensing element 54 comprises one or more sensors (not shown) operable therewith that sense or measure a characteristic or corresponding attribute of the applied force, which sensors are configured to output various data signals that can be received and processed by one or more processing means. These data signals are intended to facilitate the determination of the location and profile of the applied force about the contacting element 14 by providing the necessary data to be used by the processing means to calculate the location and profile of the applied force.

In the embodiment shown, the sensing element 54 comprises a periphery or perimeter 62 circumscribing a contact surface 58. The sensing element 54 further comprises a mounting portion 66 configured to secure the sensing element 54 to a support structure (not shown) capable of facilitating operation of the projected force-based input device 10. The mounting portion 66 may be located anywhere about the sensing element 54. In addition, the mounting portion 66 may comprise a single component or multiple different components. For example, in the exemplary embodiment of FIG. 1, the mounting portion 66 may comprise an inner mounting portion 68 and an outer mounting portion 70, each of which are discussed in greater detail below.

The mounting portion 66 is configured to secure the sensing element 54, with the mounting portion 66 being in a fixed position relative to a sensing portion 72 that is able to displace with respect to the mounting portion 66 in response to the applied force as transferred to the sensing portion 72 of the sensing element 54. The sensing portion 72 has coupled thereto the one or more transfer elements 94, thus functioning as that part of the sensing element 54 that receives the applied force acting on the projected contacting element 14, as transferred thereto. The sensing element 54 is operable with the sensors to measure one or more characteristics or corresponding attributes of the applied force, which sensors then output corresponding data to a processor for determining the location and profile of the applied force on the contacting surface 14.

As indicated above, the sensing element may comprise many different types of sensing devices. For example, the present invention sensing element may comprise a force-based sensing device, such as any one of those described in copending U.S. patent application Ser. No. 11/402,694, filed Apr. 11, 2006, and entitled, “Force-based Input Device (Attorney Docket No. 24347.NP); and U.S. Provisional Patent Application No. 60/875,108, filed Dec. 14, 2006, and entitled, “Force-based Input Device Utilizing a Modular or Non-Modular Sensing Component,” (Attorney Docket No. 02089-32349.PROV), each of which are incorporated by reference in their entirety herein.

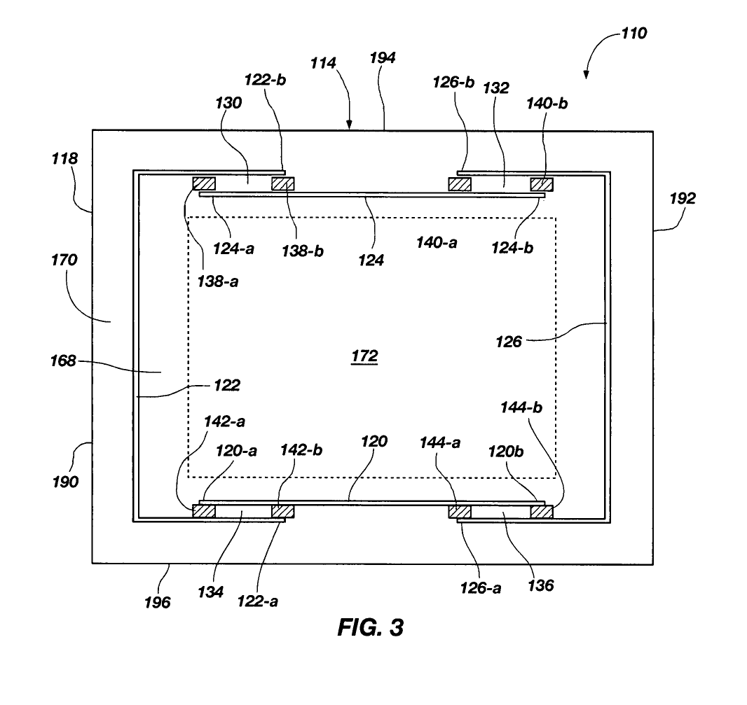

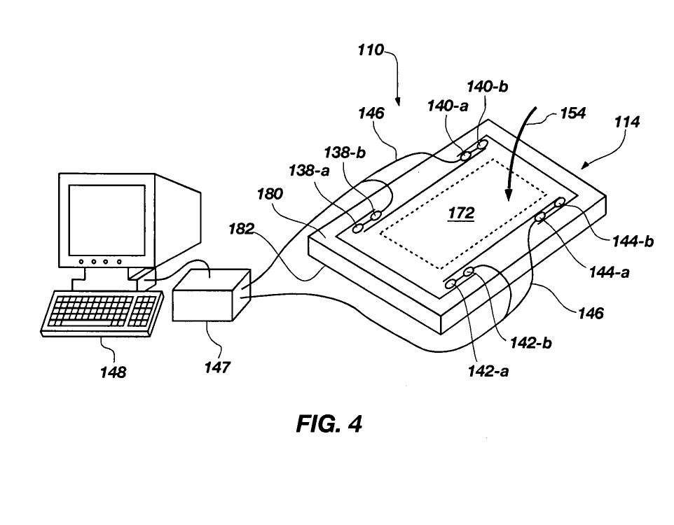

More specifically, with reference to FIGS. 3 and 4, illustrated is a force-based sensing device 110 in accordance with one exemplary embodiment. The exemplary sensing device 110 is shown as comprising a base support 114 having an outer periphery 118. A plurality of apertures 120, 122, 124, and 126 can be formed in the base support 114 within the periphery 118. The apertures 120, 122, 124, and 126 can be located along the periphery 118 and can circumscribe and define a substantially rectangular input portion 150, shown by dashed lines in FIG. 3, that functions as the sensing portion of the sensing device 110, as identified above in FIG. 1. The plurality of apertures can also define a plurality of isolated beam segments, shown as isolated beam segments 130, 132, 134, and 136, located between the periphery 118 and the corners of the sensing portion 172, parallel to the sides of the sensing portion 172.

Various sensors may be disposed on or about each isolated beam segment, respectively. As shown, each isolated beam segment 130, 132, 134, and 136 comprises two sensors, shown as sensors 138-a and 138-b located on and operable with isolated beam segment 130, sensors 140-a and 140-b located on isolated beam segment 132, sensors 142-a and 142-b located on and operable with isolated beam segment 134, and sensors 144-a and 144-b located on and operable with isolated beam segment 136. The particular sensors are configured to detect and measure the force applied to the sensing portion 172, or a resulting characteristic thereof, as transferred thereto via the transfer elements discussed above and shown in FIGS. 1 and 2. In addition, the sensors are configured to output an electronic signal, comprising sensor data, through a transmission device 146 attached or otherwise related to the sensors, which signal corresponds to the applied force as detected by the sensors.

In one exemplary embodiment, the sensors each comprise a strain gage configured to measure the strain within or across each of the respective isolated beam segments. Moreover, although each isolated beam segment is shown comprising two sensors located or disposed thereon, the present invention is not limited to this configuration. It is contemplated that one, two or more than two sensors may be disposed along each of the isolated beam segments depending upon system constraints and other factors. In addition, it is contemplated that the isolated beam segments themselves may be configured as sensors. The sensor are discussed in greater detail below.

The transmission device 146 is configured to carry the sensors' output signal and sensor data to one or more signal processing devices, shown as signal processing device 147, wherein the signal processing devices function to process the signal in one or more ways for one or more purposes. For example, the signal processing devices may comprise analog signal processors, such as amplifiers, filters, and analog-to-digital converters. In addition, the signal processing devices may comprise a micro-computer processor that feeds the processed signal to a computer 148, as shown in FIG. 4. Or, the signal processing device may comprise the computer 148, itself. Still further, any combination of these and other types of signal processing devices may be incorporated and utilized. Typical signal processing devices and methods are known in the art and are therefore not specifically described herein.

Processing means and methods employed by the signal processing device for processing the signal for one or more purposes, such as to determine the coordinates of a force applied to the force-based touch pad, are also known in the art. Various processing means and methods are discussed in further detail below.

With reference again to FIGS. 3 and 4, the base support 114 is shown comprising a substantially flat, or planar, pad or plate. The base support 114 can have an outer mounting portion 170 and an inner mounting portion 168 that can lie essentially within the same plane in a static condition. The outer mounting portion 170 can be located between the periphery 118 and the apertures 120, 122, 124, and 126. The inner mounting portion 168 can be located between the sensing portion 172 and the apertures 120, 122, 124, and 126. The isolated beam segments 130, 132, 134, and 136 can operably connect the inner mounting portion 168 with the outer mounting portion 170. The outer mounting portion 170 can be mounted to any suitably stationary mounting structure configured to support the sensing device 110, and the projected contacting surface (not shown) operable therewith. The sensing portion 172 can be a separate structure mounted to the inner mounting portion 168, or it may be configured to be an integral component that is formed integrally with the inner mounting portion 168. In the embodiment where the sensing portion is a separate structure, one or more components of the sensing portion can be configured to be removable from the inner mounting portion. For example, the sensing portion 172 may comprise a large aperture formed in the base support 114, and a removable force panel configured to be inserted and supported within the aperture, which force panel may be configured to receive the applied force as transferred thereto from either direction.

The base support 114 can be formed of any suitably inelastic material, such as a metal, like aluminum or steel, or it can be formed of a suitably inelastic, hardened polymer material, as is known in the art. In addition, the base support 114 may be formed of glass, ceramics, and other similar materials. The base support 114 can be shaped and configured to fit within any type of suitable interface application.

It is noted that the performance of the sensing device 110 may be dependent upon the stiffness of the mounting portion, such as the outer mounting portion, of the base support 114. As such, the base support 114, or at least appropriate portions thereof, should be made to comprise suitable rigidity or stiffness so as to enable the sensing device to function properly, particularly with the transfer and contacting elements operable with the sensing device. Alternatively, instead of making the base support 114 stiff, the base support 114, or at least a suitable portion thereof, may be attached to some type of rigid support. It is recognized that suitable rigidity functions to facilitate more accurate input readings.

The sensing portion 150 can be a substantially flat, or planar, pad or plate and can lie within the same plane as the base support 114. The sensing portion 172 can be circumscribed by the apertures 120, 122, 124, and 126.

The sensing portion 172 is configured to displace in response to various stresses induced in the sensing portion 172 resulting from application of a force acting on the contacting portion (not shown) and transmitted to the sensing element. The sensing portion 172 is further configured to transmit the stresses induced by the applied force to the inner mounting portion 168 and eventually to the isolated beam segments 130, 132, 134, and 136 where resulting strains in the isolated beam segments are induced and measured by the one or more sensors.

The base support 114 and sensing portion 172 can have a first side 180 and a second side 182. The present invention projected force-based input device advantageously provides for the transfer of force to either the first or second sides 180 and 182 of the sensing portion 172, and the sensing portion 172 may be configured to displace out of the plane of the base support 114 in either direction in response to the applied force.

The sensing portion 172 can be formed of any suitably rigid material that can transfer, or transmit the applied force to the sensors. Such a material can be metal, glass, or a hardened polymer, as is known in the art.

The isolated beam segments 130, 132, 134, and 136 can be formed in the base support 114, and may be defined by the plurality of apertures 120, 122, 124, and 126. The isolated beam segments 130, 132, 134, and 136 can lie essentially in the same plane as the base support 114 and the sensing portion 172 when in a static condition. In some embodiments, the apertures 120, 122, 124, and 126 may be configured to extend all the way through the base support 114. For example, the apertures 120, 122, 124, and 126 can be through slots or holes. In other embodiments, the isolated beam segments 130, 132, 134 and 136 may be configured to extend only partially through the base support 114.

As illustrated in FIG. 3, the isolated beam segment 130 can be formed or defined by the apertures 122 and 124. Aperture 122 can extend along a portion of the periphery 118 and have two ends 122-a and 122-b. The aperture 124 can extend along another portion of the periphery and have two ends 124-a and 124-b. Portions of the two apertures 122 and 124 can overlap and extend along a common portion of the periphery 118 where one end 122-b of aperture 122 overlaps an end 124-a of aperture 124. The two ends 122-b and 124-a, and the portions of the apertures 122 and 124 that extend along the common portion of the periphery 118, can be spaced apart on the base support 114 a pre-determined distance. The portion of the aperture 122 that extends along the common portion of the periphery 118 can be closer to the periphery 118 than the portion of the aperture 124 that extends along the common portion of the periphery 118. The area of the base support 114 between the aperture 122 and the aperture 124, and between the end 122-b and the end 124-a, can define the isolated beam segment 130.

The isolated beam segments 132, 134, and 136 can be similarly formed and defined as described above for isolated beam segment 130. Isolated beam segment 132 can be formed by the area of the base support 114 between the apertures 124 and 126, and between the ends 124-b and 126-b, respectively. Isolated beam segment 134 can be formed by the area of the base support 114 between the apertures 120 and 122, and between the ends 120-a and 122-b. Isolated beam segment 136 can be formed by the area of the base support 114 between the apertures 120 and 126, and between the ends 120-b and 126-a. Thus, all of the isolated beam segments can be defined by the various apertures formed within the base support 114. In addition, the isolated beam segments may be configured to lie in the same plane as the plane of the sensing portion 172 and base support 114, as noted above.

The plurality of apertures 120, 122, 124, and 126 can nest within each other, wherein apertures 122 and 126 extend along the sides 190 and 192, respectively, of the rectangular base support 114, and can turn perpendicular to the short sides 190 and 192 and extend along at least a portion of the sides 194 and 196 of the base support 114. Apertures 120 and 124 can be located along a portion of the sides 196 and 194, respectively, of the base support 114 and closer to the sensing portion 172 than apertures 122 and 126. Thus, apertures 120 and 124 can be located or contained within apertures 122 and 126. Stated differently, the apertures may each comprise a segment that overlaps and runs parallel to a segment of another aperture to define an isolated beam segment, thus allowing the isolated beam segments to comprise any desired length.

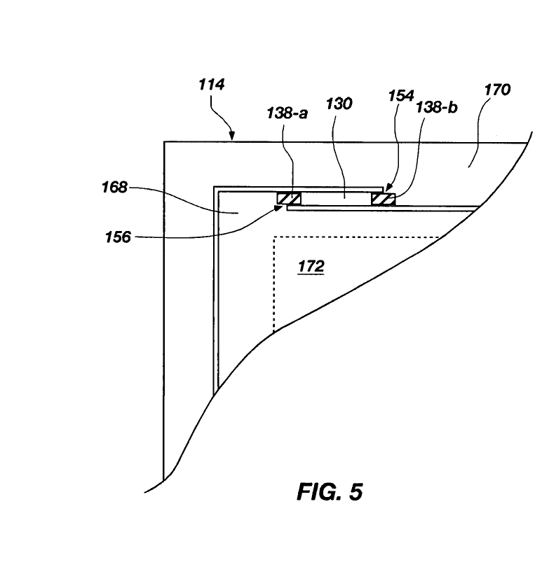

As illustrated in FIG. 5, the isolated beam segment 130 may comprise an outer or periphery juncture 154, formed with the outer mounting portion 170, and an inner juncture 156, formed with the inner mounting portion 168 of the base support 114. The inner juncture 156 and outer juncture 154 are configured to receive and concentrate the stresses induced on the base support 114 by the applied force to the isolated beam segment 130 by deflecting or bending in opposite directions. Upon the transfer of a force to the sensing portion 172 from the projected contacting element (not shown), at least a portion of the resultant forces are transmitted through or from the sensing portion 172 to the isolated beam segment 130 as a result of the configuration of the isolated beam segment 130, and specifically the inner and outer junctures 154 and 156, in relation to the sensing portion 172 and the inner mounting portion 168. For example, when a force is transferred to the sensing portion 172 from the contacting element via the transfer element(s), the sensing portion 172 displaces and induces stresses in the sensing portion 172. A portion of these stresses can be transmitted from the sensing portion 172 to the inner mounting portion 168, and ultimately to the isolated beam segment 130 where sensors 138-a and 138-b function to detect and measure the strain within the isolated beam segment 130. It is this measured characteristic or attribute of the applied force that the sensor data comprises. Although not shown in FIG. 5, each of the other isolated beam segments (see FIGS. 3 and 4) discussed above function in a similar manner.

With reference again to FIGS. 3 and 4, upon receiving the forces or stresses, the isolated beam segments 130, 132, 134, and 136 are configured to deflect in response to the displacement of the sensing portion 172 in response to the force being applied to the sensing portion 172 as transferred thereto from the contacting element (not shown). Thus, the force as transferred and applied to the sensing portion 172 and the resultant stresses induced in the sensing portion 172 can be directed to and concentrated in the isolated beam segments 130, 132, 134, and 136. The concentrated stresses can result in deflection of the isolated beam 130, 132, 134, and 136 segments, and the deflection can be measured by the sensors 138-a and 138-b, 140-a and 140-b, 142-a and 142-b, and 144-a and 144-b, respectively.

The sensors 138-a and 138-b, 140-a and 140-b, 142-a and 142-b, and 144-a and 144-b can be located along each isolated beam segment 130, 132, 134, and 136, respectively, essentially in the same plane as the base support 114 and the sensing portion 172 when in a static condition. Specifically, as shown in FIGS. 3 and 4, a sensor can be located at each end of each isolated beam segment. Thus, a sensor 138-a can be located on isolated beam segment 130 near the end 124-a of the aperture 124. Similarly, another sensor 138-b can be located on the isolated beam segment 130 near the end 122-b of the aperture 122. The sensor 140-a can be located on isolated beam segment 132 near aperture end 126-b of aperture 126, and sensor 140-b can be located on isolated beam segment 132 near aperture end 124-b of aperture 124. The sensor 142-a can be located on isolated beam segment 134 near aperture end 120-b of aperture 120, and sensor 142-b can be located on isolated beam segment 134 near aperture end 122-b of aperture 122. The sensor 144-a can be located on isolated beam segment 136 near aperture end 126-a of aperture 126, and sensor 144-b can be located on isolated beam segment 136 near aperture end 120-b of aperture 120.

The sensors 138-a and 138-b, 140-a and 140-b, 142-a and 142-b, and 144-a and 144-b can also be located along each isolated beam segment 130, 132, 134, and 136 in a different plane than the base support 114 and the sensing portion 172 when in a static condition. The sensors 138-a and 138-b, 140-a and 140-b, 142-a and 142-b, and 144-a and 144-b do not necessarily have to be in the same plane as the sensing portion 172, nor do they have to lie within the same plane with respect to one another. In the embodiment shown, the sensors 138-a and 138-b, 140-a and 140-b, 142-a and 142-b, and 144-a and 144-b do lie within the same, what may be referred to as, sensor or sensing plane. For example, an isolated beam segment having a side in the same plane as the sensing portion 172, and a side in an offset plane from the sensing portion 172 can have the sensor plane located on the side that is in the same plane as the sensing portion 172, or can have the sensor plane located on the side that is offset to the plane of the sensing portion 172. In either case, the sensors are configured to lie within a common sensor plane.

Alternatively, the sensing element may comprise a structure having a non-planar configuration, or one with different elevations along its surface. In this case, the sensors may lie within different planes with respect to one another, and therefore, the sensing element may comprise a number of different sensor planes. The complexity of the sensing element and any resulting complexity in the location of the sensors may be accounted for in the processing means used to determine the location and profile of the applied force.

The sensors 138-a and 138-b, 140-a and 140-b, 142-a and 142-b, and 144-a and 144-b are configured to measure the deflection in the isolated beam segments 130, 132, 134, and 136, respectively, caused by the applied force acting on the sensing portion 172 as transferred thereto from the contacting element via the transfer element(s). The sensors 138-a and 138-b, 140-a and 140-b, 142-a and 142-b, and 144-a and 144-b can be any type of sensor capable of measuring properties related to displacement of the isolated beam segments 130, 132, 134, and 136. For example, the sensors can be strain gages, capacitance gages, liquid level gages, laser level gages, piezo sensors or any suitable sensor as is known in the art. The sensors 138-a and 138-b, 140-a and 140-b, 142-a and 142-b, and 144-a and 144-b can generate an electrical signal comprising sensor data corresponding to the displacement of the isolated beam segments 130, 132, 134, and 136. The electrical signal can be transmitted from the sensors 138-a and 138-b, 140-a and 140-b, 142-a and 142-b, and 144-a and 144-b via one or more transmission means.

The transmission means may comprise a wired or wireless transmission means, including for example, electrical wires 146, such as those shown in FIG. 4, a radio transmitter, optical communication devices, and/or others as known in the art. The transmission means is configured to carry the signal output by each of the various sensors to a signal processor or signal processing means, shown as signal processor 147, configured to receive and analyze the electrical signal and corresponding sensor data to determine the location, profile and/or magnitude of the applied force on the projected contacting element and sensing portion 172. The processing means and analysis methods can be any known in the art.

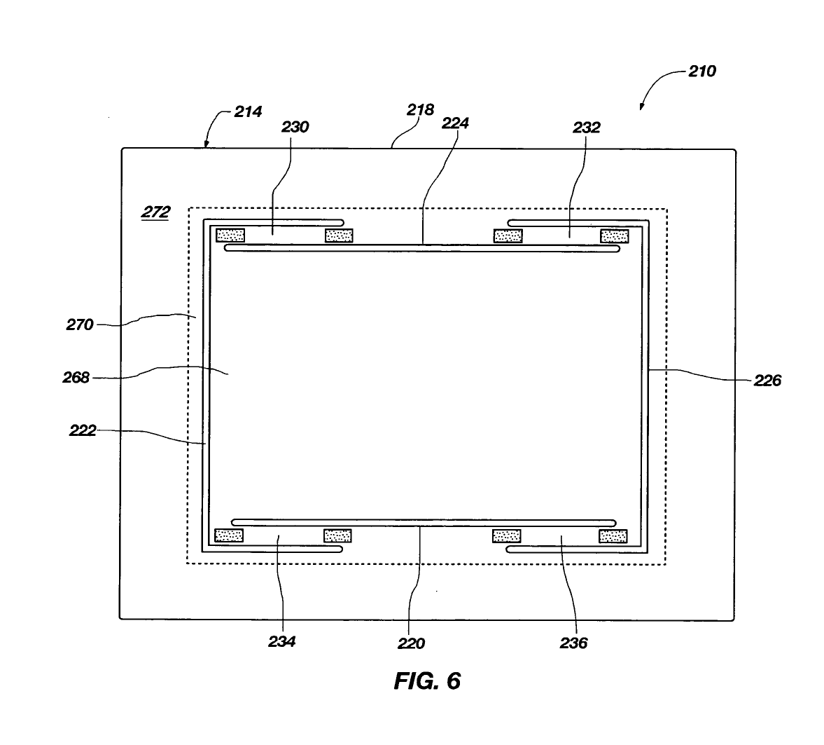

FIG. 6 illustrates a force-based sensing device 210 in accordance with still another exemplary embodiment of the present invention. In this particular embodiment, the sensing device 210 comprises a base support 214 having an outer periphery 218. A plurality of apertures 220, 222, 224, and 226 can be formed in the base support 214 within the periphery 218. The apertures 220, 222, 224, and 226 can be located along the periphery 218 and can define a substantially rectangular sensing portion 272 formed about the periphery 218, as delineated by dashed lines in FIG. 6. The plurality of apertures can also define a plurality of isolated beam segments, 230, 232, 234, and 236, near the corners of, and parallel to the sides of the sensing portion 272, each of which may be operable with one or more sensors as shown.

The base support 214 is shown comprising a substantially flat, or planar, pad or plate. The base support 214 can have an outer mounting portion 270 and an inner mounting portion 268 that can lie essentially within the same plane in a static condition. The outer mounting portion 270 can be located between the periphery 218 and the apertures 220, 222, 224, and 226, as well as between the input pad 250 and the various apertures. In other words, the input pad 250 may be configured to circumscribe the outer mounting portion 270. The inner mounting portion 268 can be located inside of the various apertures 220, 222, 224, and 226, or in other words be circumscribed by the various apertures 220, 222, 224, and 226. The isolated beam segments 230, 232, 234, and 236 can connect the inner mounting portion 268 with the outer mounting portion 270. The outer mounting portion 270 can be mounted to any suitably stationary mounting structure configured to support the sensing device 210. The sensing portion 272 can be a separate structure mounted to the outer mounting portion 270, or it may be configured to be an integral component that is formed integrally with the outer mounting portion 270.

The sensing portion 272, as supported about and integral with the periphery 218 is configured to displace in response to various stresses induced in the sensing portion 272 resulting from application of a force acting on the projected contacting element (not shown) and transferred to the sensing portion 272. The sensing portion 272 is further configured to transmit the stresses induced by the applied force to the outer mounting portion 270 and eventually to the isolated beam segments 230, 232, 234, and 236 where resulting strains in the isolated beam segments are induced and measured by the one or more sensors in a similar manner as described above with respect to the embodiment shown in FIG. 3.

Essentially, the sensing device embodiment illustrated in FIG. 6 is similar to that shown in FIG. 3, except that the sensing portion 272 of FIG. 6 is located about the perimeter or periphery of the sensing device with the inner and outer mounting portions being positioned inside or interior to the sensing portion 272. In other words, the sensing device of FIG. 6 may be considered to comprise a structural configuration that is the inverse of the sensing device shown in FIG. 3. This particular embodiment is intended to illustrate that the present invention broadly contemplates some embodiments of the sensing device as comprising a first structural element supported in a fixed position, and a second structural element operable with the first structural element, wherein the second structural element is dynamically supported to be movable with respect to the first structural element to define a sensing portion configured to displace under an applied force.

With respect to the embodiments shown and others described in the above-identified patent applications which have been incorporated by reference, the combination of providing isolated beam segments, such as isolated beam segments that lie in or substantially in the same plane as the sensing portion or modular-type isolated beam segments or those that lie in different planes, and configuring the sensing element to direct and concentrate the stresses occurring within the sensing portion to/within the isolated beam segments, as well as the coplanar or substantially coplanar or non-planar relationship of the sensors with the sensing portion, provides significant advantages over prior related force-based sensing devices. These advantages include, but are not limited to, being able to create the entire sensing device, including the mounting elements or portions, from a single piece of material by means of appropriately forming and locating the apertures in the material; being able to reduce the sensitivity of the sensing device to longitudinal forces or moments transmitted to the sensing portion; being mechanically simple; being able to eliminate preload springs; being able to provide a rugged and robust design that protects the sensing device from the environment; being able to minimize size and weight by making the sensors integral with and coplanar to the sensing portion; and being able to register forces from either side of the sensing device. Furthermore, ceramic piezoelectric transducers deployed in the more sensitive longitudinal mode with the strain applied perpendicular to the axis of the poles and parallel to the electrodes makes the sensors more sensitive to elongation or strain and less sensitive to shear and transverse forces, thereby reducing the need for elaborate mechanisms to isolate the transducers from unwanted forces.

The present invention sensing element may comprise several other embodiments or other types of force-based sensing devices, some of which may or may not function in a similar manner as the exemplary force-based sensing devices described above or incorporated by reference herein. As such, those discussed or incorporated by reference herein are not intended to be limiting in any way. Indeed, it is contemplated that other embodiments and other types of sensing elements (e.g., other types of force-based sensing devices) will fall within the scope of the present invention that are not specifically set forth herein. For example, some additional force-based sensing devices that may be used with the present invention projected or elevated contacting element are described in U.S. Pat. Nos. 3,657,475 to Peronneau et al.; 4,121,049 to Roeber; 4,340,777 to DeCosta et al.; 4,389,711 to Hotta et al.; 4,511,760 to Garwin et al.; and 4,558,757 to Mori et al. Still other types of force-based sensing devices are contemplated.

The sensing element 54 may be comprised of any material that provides sufficient strength so as to be operable within a particular application, that provides sufficient elastic deformation under the forces to be detected by the sensors, and that provides a repeatable response under environmental conditions (e.g., force, temperature, etc.). In the case of strain gages, this includes many metals (e.g., aluminum, steel, bronze, etc.), and a variety of polymers (e.g., polycarbonate). In the case of piezo sensors, much less elastic materials may be used, such as a thicker, tempered steel. Most sensors will be constructed of metals (due to its high ratio of elasticity to deformation) or polymers (due to their inexpensive production costs).

With reference again to FIG. 2, the general projected force-based input device 10 is configured to receive one or more applied forces about the contact surface 18 of the contacting element 14, which applied forces are shown as forces F. The input device 10, and particularly the contacting element 14, may be configured to receive an applied force anywhere along its contact surface 18. Alternatively, the contact surface 18 may comprise a designated input portion or area 26 that may be defined by one or more boundaries, which input portion 26 may be caused to exist anywhere along the contact surface 18. In addition, the designated input portion 26 may comprise all or only a portion of the area about the contact surface 18.

The contacting element 18, as indicated above, is a projected or elevated element with respect to the sensing element 54, which is the element actually configured to sense the applied force(s). As such, the projected contacting element 14 is intended to be supported in such a projected or elevated position, and to relate to the sensing element 54 in such a way so as to properly transmit the forces applied to its contact surface 18 to the sensing element 54. This is done using one or more transfer elements 94 that act to both support the contacting element 14 in a projected position, as well as to provide a conduit for the applied forces to be transmitted from the contacting element 14 to the sensing element 54 in such a manner so as to provide an accurate measurement of the force(s) and/or one or more measurable characteristics thereof. Each of the contacting element 18, the sensing element 54 and the transfer elements 94 are designed so that all or substantially all of the forces are transferred to the sensing element 54.

The transfer elements 94, as coupled to the contacting element 14 and the sensing element 54, each comprise a central mounting point and a longitudinal central axis extending therethrough. Generally speaking, a force may be applied at any location on the contacting element 14, which force may be offset from the central mounting point and longitudinal axis of the transfer elements 94. The location of the applied force with respect to the location of the transfer elements 94 will affect the resultant force transferred to the sensing element 54. As shown in FIG. 2, force F₁ will induce an inverse affect on the contacting element 14, the transfer element 94, and the sensing element 54 as compared with force F₂ due to their relative points of application about the contacting element 14 with respect to the location and the longitudinal axis of the transfer element 94. The forces and the location of the forces as applied are discussed in greater detail below.

The present invention projected force-based input device may further comprise multiple projected contacting elements located in a projected or elevated position away from a sensing element, as supported by corresponding transfer elements. As shown in FIG. 2 in phantom, the input device 10 comprises a second projected contacting element 14-a and corresponding one or more transfer elements 94-a to support the second contacting element 14-a. The single sensing element 54 is shown as having first and second contacting elements 14 and 14-a, respectively, located in opposing projected positions thereabout, with each being supported by one or more transfer elements. In this configuration, the sensing element 54 is configured to sense any applied forces acting on one or both of the contacting elements and to determine the location and profile of the applied forces acting on the various contacting elements. This double-sided configuration may be suitable for one or more applications.

As one or more forces are being applied to the contacting element, no matter the location of the applied forces about the surface of the contacting element, the applied forces are conveyed or transferred to the transfer elements and subsequently to the sensing portion of the sensing element as transferred forces where they are sensed by the sensor elements in the sensing portion of the sensing element to determine the location, profile and/or magnitude of the applied force(s).

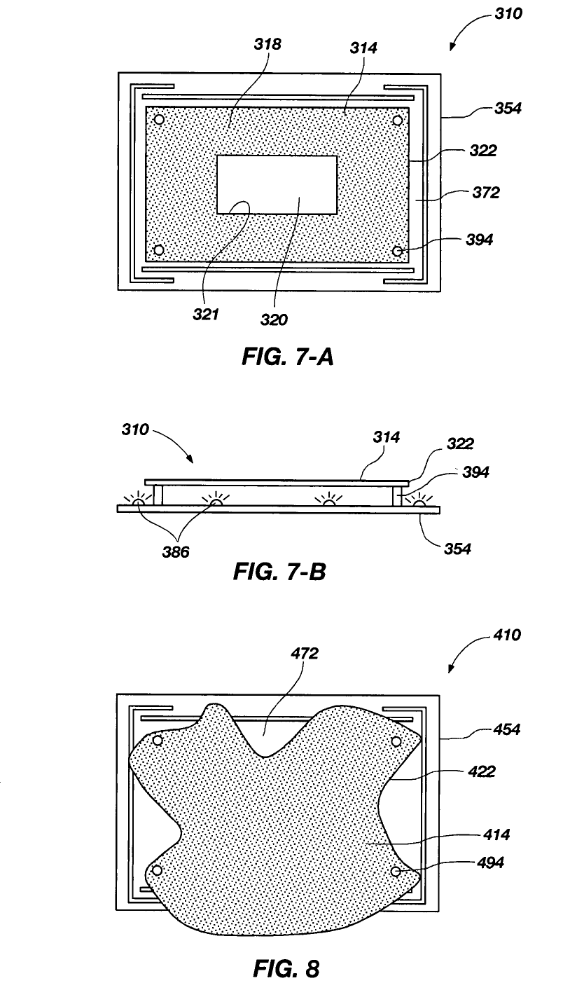

The following FIGS. 7-A-9-B illustrate various exemplary alternative design embodiments for a projected or elevated force-based input device having one or more suitably rigid components. With specific reference to FIGS. 7-A and 7-B, illustrated are respective top and side views of a projected or elevated force-based input device in accordance with one exemplary embodiment. As shown, the elevated force-based input device 310 comprises a projected contacting element 314 supported in a different elevation from the sensing element 354. The contacting element 314 is operably related to the sensing element 354 via the several transfer elements 394 (shown as four in number) configured to support the contacting element 314 in its projected or elevated position, as well as to receive and transfer all or substantially all of the forces acting on or about the contacting element 314 to the sensing element 354, as discussed above.

In this particular embodiment, the contacting element 314 comprises a flat, planar structure having a rectangular geometric configuration, with its entire periphery or perimeter 322 contained within the edges of the sensing element 354 (as viewed from a top view). In other words, there is no portion of the contacting element 314 that extends beyond the sensing element 354, when observed from the top, as shown in FIG. 7-A, or from the side as shown in FIG. 7-B. Furthermore, it is also shown that no portion of the contacting element 314 extends beyond the sensing portion 372 of the sensing element 354, as viewed from the top.

The contacting element 314 is further shown as comprising a cut-out portion 320 having a periphery or perimeter 321. The cut-out region 320 may be any size, and the contacting element 314 may comprise any number of cut-outs. The cut-out portion 320 does not affect those portions of the surface 318 of the contacting element 314 capable of receiving and registering an applied force. The cutout portion 320 may be used for a variety of purposes. For example, the cutout portion may be support a glass or acrylic screen for use as a display. The cutout portion 320 may also be used to facilitate the mounting of various items to the contacting element 314. In another application, the cutout portion may be used to create a “virtual touch” region. In this sense, forces may be applied to the contacting element to effectively cause the input device 314 to register a touch in a location within the cutout region as if the contacting element comprised structure or surface structure in that region. Stated differently, the present invention may be configured to average the location of multiple simultaneous applied forces, such that the sum of these forces causes the system to register a location at coordinates within a cutout region. For example, if a virtual touch was desired to be registered in the center of the cutout region 320, multiple simultaneous forces may be applied to the contact surface 318 of the contacting element 314, which multiple simultaneous forces are equidistant from the center of the cutout region, along the same axis, and of the same magnitude. The idea behind this being that the input device may be used in applications requiring a safety function in order to operate a device (e.g., where two hands are required to start a piece of equipment to prevent one hand from being inside the equipment and the device inadvertently started).

The sensing element 354 is also shown as comprising a flat, planar structure having a rectangular geometric configuration. The sensing element 354 comprises a sensing portion 372 that is configured and that functions in a similar manner as that discussed above and described in FIGS. 3-5.

FIGS. 7-A and 7-B further illustrate transfer elements 394 as comprising the same length, thus supporting the flat, planar contacting element 314 in an elevated or projected plane parallel to that defined by the flat, planar sensing element 354. The transfer elements 394 are strategically positioned about the sensing portion 372 of the sensing element 354, namely near its edges or perimeter, but such is not required as the transfer elements may extend between the contacting and sensing elements at various positions. Each transfer element 394 extends upward and contacts the projected contacting element 314, being coupled to the underside of the contacting element 314 near its edges or perimeter 322, so that a majority of applied forces will take place on or about the surface of the contacting element 314 at a location within or interior to the transfer elements 394, and between the transfer elements 394 and a central axis of the input device 310. More specifically, the transfer elements 394 are shown as being positioned or located in each of the four corners of the contacting element 314.

The transfer elements 394, as configured to transfer forces, are configured with a degree of rigidity. In some embodiments, the transfer elements will be more rigid than in other embodiments. This may depend upon the particular application, the types of loads or forces that will be applied, and other factors. Another factor that may determine the needed rigidity of the transfer elements is the distance the projected contacting element is to be away from the sensing element, as defined by the height of the transfer elements 394. Generally speaking, the greater the length of the transfer elements 394 and the resulting projected height of the contacting element 314 with respect to the sensing element 354, the more rigid the transfer elements 394 may need to be in order to avoid interference of the contacting or sensing elements with the mounting structure or another object (e.g., a partition, such as a wall, trim plate or panel). In essence, and in most cases, the transfer elements 394 are intended to be designed so that all or substantially all of the applied forces on the contacting element 314 are transferred to the sensing element 354 via the force transfer elements 394. While the height of the transfer elements themselves does not necessarily affect the transfer of forces, their height may contribute to their overall flexibility. The particular design or configuration of the transfer elements 394, as well as their material makeup, may be determined by those skilled in the art when considering the particular application in which the input device 310 will be used. It has been discovered that as the contacting element 314 is spaced further from the sensing element 354, the sensing element 354 becomes increasingly sensitive to the components of the force parallel to the sensing element 354, or off-axis forces (those in acting along or within the x-y coordinates or axes or plane of the input device), which may, in some cases, impose a practical limit on the separation or projection distance of the contacting element 314.

FIG. 7-B further illustrates one or more lighting means or light sources 386 supported between the contacting element 314 and the sensing element 354, and located at various locations within the input device. By installing lights between the contacting element 314 and the sensing element 354 (or between the contacting element and a partition (see FIG. 13)), various aesthetic effects or functional capabilities may be realized. The light sources 386 may be any known in the art, such as LED's, incandescent, fiber optics, light pipes, and others. In addition, the light sources 386 may be any color, and can be configured to provide different effects, such as continuously on, blinking, strobing, dimming, synchronized with music, etc. The light sources may be controlled by a on/off touch region on the contacting element, or by more traditional means, such as a physical switch.

As shown, the light sources are mounted to the sensing element 314, but they could also be mounted to the contacting element 354, the transfer element(s) 394, or any other structure operating with the input device 310.

With reference to FIG. 8, illustrated is a projected force-based input device in accordance with another exemplary embodiment. As shown, the projected force-based input device 410 comprises a projected contacting element 414 supported in a different elevation from the sensing element 454. The contacting element 414 is operably related to the sensing element 454 via the several transfer elements 494 (shown as four in number) configured to support the contacting element 414 in its projected position, as well as to receive and transfer all or substantially all of the forces acting on or about the contacting element 414 to the sensing element 454, as discussed above.

In this particular embodiment, the contacting element 414 comprises a flat, planar structure having an arbitrary geometric configuration, wherein a combination of differently curved and straight segments define the perimeter 422 of the contacting element 414. The purpose of this particular embodiment is to illustrate that the contacting element 414 may comprise any arbitrary shape, as well as to also define a perimeter that may be within or without the perimeter of the sensing element (as viewed from a top view), or both. As such, the particular arbitrary shape shown in FIG. 8 is not intended to be limiting in any way.

FIG. 8 further illustrates various portions of the contacting element 414 extending beyond the perimeter of the sensing portion 472, as well as the edges or perimeter of the sensing element 454. As such, there is provided various portions or segments of the surface of the contacting element 414 also extending beyond the sensing portion 472 and sensing element 454, which surfaces may receive a force. With the transfer elements 494 positioned about the edges of the sensing portion 472, or more specifically substantially within its corners, and with various portions of the contacting element 414 providing surface areas that extend beyond the sensing portion 472, it is possible that the contacting element 414 may receive forces that are applied between the transfer elements 494 and a central axis of the input device, as well as forces that are applied between the perimeter 422 of the contacting element 414 and the transfer elements 494. As such, the sensing element 454 is configured to account for the different affects such forces will have on the input device 410. Indeed, the contacting element 414 and the input device 410 will operate even though a portion of the touch receiving surface of the contacting element 414 extends beyond the sensing element 454. Forces that are applied outside of the sensor locations of the sensing element 454 will cause opposing sensors to respond as if to a negative force. However, as stated, the processing means may be configured to account for such in order to provide accurate results.

Moreover, adequate rigidity within the contacting element and the transfer elements should be maintained for any portion of the contacting element that is to receive a force. The projected distance of the contacting element away from the sensing element does not significantly affect the accuracy of the input device for forces applied orthogonally to the contacting element. However, the projection distance does amplify the effect of any off-axis forces. This amplification is directly related to the ratio of the projection distance to the separation distance of the sensors. The larger the projected distance of the contacting element relative to the spacing between sensors, the larger the amplification of the off-axis forces, and the more potential for error in the calculated x-y position of the applied force. However, such may be accounted for electrically, via software, mechanical modifications, or any of these in combination.

The sensing element 454 is also shown as comprising a flat, planar structure having a rectangular geometric configuration, which is configured and functions in a similar manner as the sensing element 354 of FIGS. 7-A and 7-B. Alternatively, in other exemplary embodiments, the sensing element may comprise a configuration having a non-planar surface, or a surface with different elevations. In addition, the sensing element may comprise a configuration similar to the contacting element shown in FIG. 8. Suffice it to say, the present invention contemplates a sensing element, a projected or elevated contacting element, and one or more force transfer elements, with each of these being able to exist in many different configurations. Although some configurations may make the calculations performed by the processing means more difficult, the input device can easily be made to operate with the sensing and contacting elements (and also the transfer elements) comprising planar or non-planar configurations, as well as various arbitrary or other shapes.

FIG. 8 further illustrates transfer elements 494, which are also configured and function in a similar manner as the transfer elements of FIGS. 7-A and 7-B, namely to support the flat, planar contacting element 414 in an elevated or projected plane parallel to that defined by the flat, planar sensing element 454.

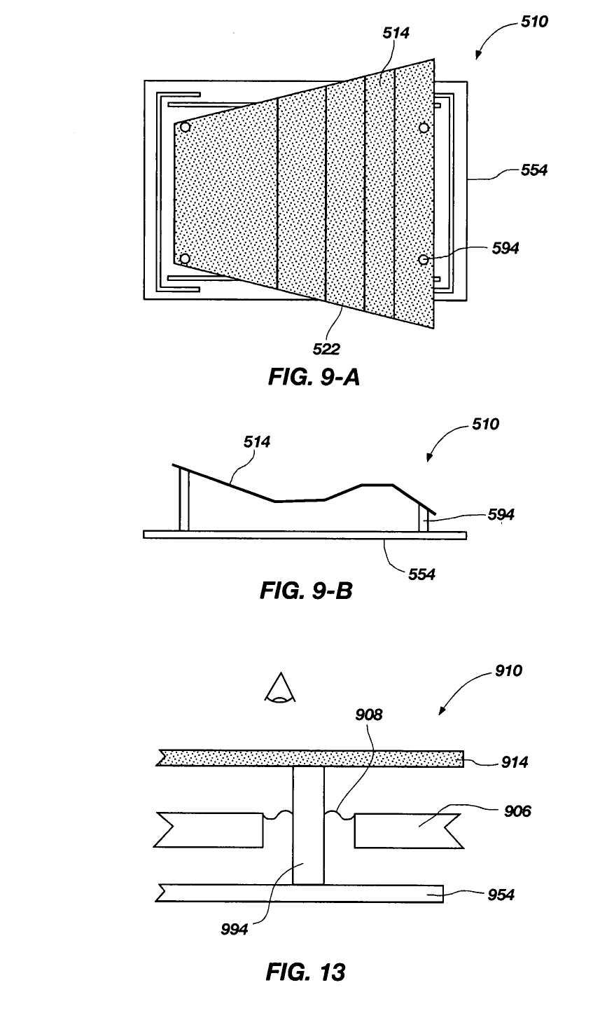

FIGS. 9-A and 9-B illustrate a projected force-based input device in accordance with another exemplary embodiment. As shown, the projected force-based input device 510 comprises a projected contacting element 514 supported in a different elevation from the sensing element 554. The contacting element 514 is operably related to the sensing element 554 via the several transfer elements 594 (shown as four in number) configured to support the contacting element 514 in its projected position, as well as to receive and transfer all or substantially all of the forces acting on or about the contacting element 514 to the sensing element 554, as discussed above.

In this particular embodiment, the contacting element 514 comprises a contoured, nonplanar structure having a multi-elevational, frustoconical geometric configuration, as viewed from the top, with a portion of its periphery or perimeter 522 contained within the edges of the sensing element 554 (as viewed from the top) and a portion extending beyond the edges of the sensing element 554, as shown. This embodiment also illustrates the ability to provide a contacting element that is comprised of different topographical elevations. As such, the particular design shown in FIGS. 9-A and 9-B is not intended to be limiting in any way. To the contrary, as will be recognized by those skilled in the art, the contacting element 514 may comprise any number of elevational changes, particularly along its upper contact or force receiving surface. In addition, an embodiment comprising a contoured surface may further comprise any geometric configuration.

The sensing element 554 is shown as comprising a similar configuration as that of FIGS. 7-8. As in other embodiments, the sensing element 554 comprises a sensing portion 572 that is configured and that functions in a similar manner as that discussed above and described in FIGS. 3-5.

FIGS. 9-A and 9-B further illustrate transfer elements 594 as comprising different lengths, thus supporting the contoured contacting element 514 in an elevated or projected position relative to the flat, planar sensing element 554. Different lengths are provided in order to account for the nonplanar configuration and the various elevations formed in the contacting element 514. Nonetheless, the transfer elements 594 are configured to provide the same function as otherwise discussed herein. If needed, the processing means may be configured to account for the nonplanar configuration. However, the calculations to determine the location, profile and/or magnitude of the forces being applied to the contacting element 514 may or may not be more complex.

The transfer elements 594 are strategically positioned about the sensing portion 572 of the sensing element 554, namely near its edges or perimeter. Likewise, each transfer element 594 extends upward and contacts the projected contacting element 514, being coupled to the underside of the contacting element 514 near its edges or perimeter 522. With the contacting element 514 so configured, some of the applied forces will take place on or about the surface of the contacting element 514 within or interior to the transfer elements 594, and between the transfer elements 594 and a central axis while some of the applied forces will occur between the perimeter 522 and the transfer elements 594.

Despite the multi-elevational configuration of the contacting element 514, normal z-axis forces will be transferred to the sensing element 554 much the same way they are with a flat, planar contacting element. The non-planar, multi-elevational contacting element may tend to produce a higher ratio of off-axis (x-y) forces to on-axis (z-axis) forces that may have to be accounted for and accommodated either mechanically, electrically or with software, or any combination of these. However, the normal forces will translate properly and the input device may be made to function with a contacting element having such a configuration.

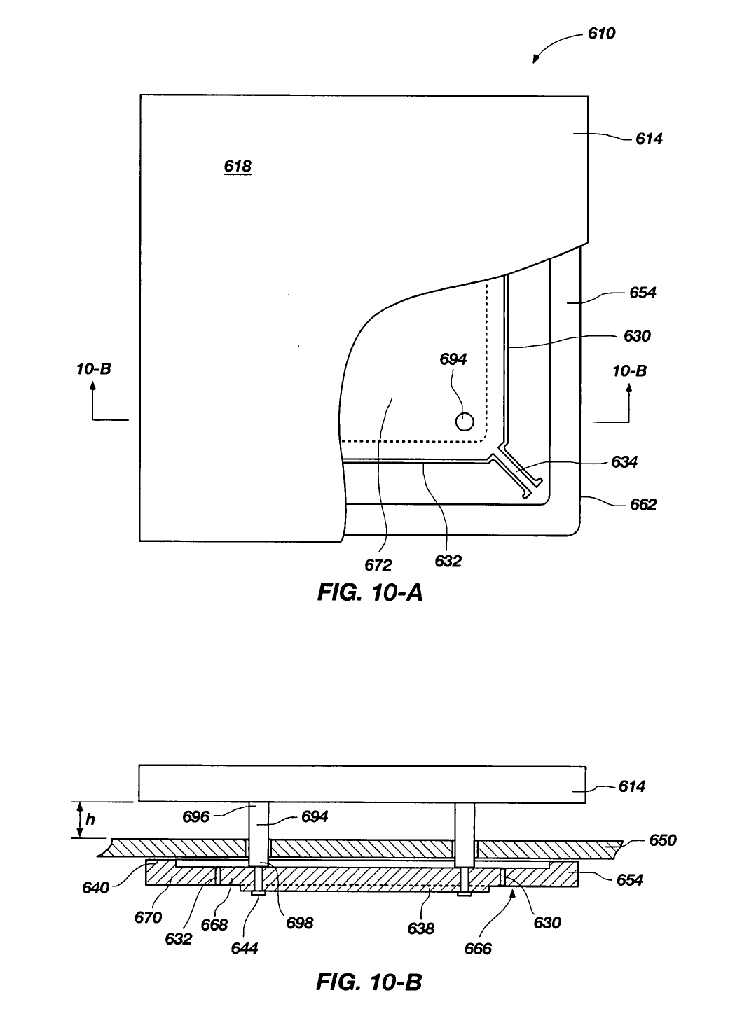

FIGS. 10-A and 10-B illustrate a projected force-based input device 610 in accordance with another exemplary embodiment. As shown, the projected force-based input device 610 comprises a contacting element 614 operably coupled and related to a sensing element 654 in a projected position, having a height h, via transfer elements 694. This embodiment is similar in form and function to the one described above and shown in FIGS. 3-5, but with some differences. As such, every feature and function is not set forth.

The contacting element 614 comprises an upper contacting surface 618 configured to receive a force applied thereto. The contacting element 614 is shown as a plate-like structure having a uniform thickness. The contacting element 614 may be formed of many different materials, including, but not limited to, glass, marble, stone, ceramic, steel, plastic, and others. In addition, also as described above, the contacting element 614 may comprise different sizes and shapes.

The sensing element 654 comprises a plurality of apertures, shown as apertures 630 and 632, which extend through the sensing element 654, and which function to create and define a plurality of isolated beam segments within the sensing element 654, only one of which is shown, namely isolated beam segment 634. The isolated beam segment 634 is shown as being positioned or oriented on an incline where it is located diagonally with respect to the perimeter 662 of the sensing portion 654. The sensing element 654 comprises additional isolated beam segments (not shown) situated in a similar manner. Each of these isolated beam segments contain one or more sensors, or are comprised of sensing material. The function of these isolated beam segments and any sensors located thereon is taught above.

The apertures 630 and 632, as well as the mounting portion 666 and movable component 638 further define a sensing portion 672 configured to receive the applied forces acting on the contacting element 614 as transferred to the sensing portion 672 through the transfer elements 694. The transfer element 694 comprises a first end 696 securely coupled to the underside of the contacting element 614, and a second end 698 that is securely coupled to the sensing element 654 via fasteners 644, which may be bolts, screws, etc. The transfer element, as well as those not shown, are each coupled to the sensing element 654 at a location within the sensing portion 672.

The sensing element 654 may be mounted via mounting portion 666, which consists of an inner mounting portion 668 and an outer mounting portion 670. The mounting portion 666 may be securely coupled to any structure capable of supporting the projected force-based input device 610. For example, the mounting portion 666 may be securely mounted to the partition 650.

FIG. 10-B further illustrates an optional partition 650 in the form of a trim plate (not shown in FIG. 10-A for clarity) that may be used for aesthetic purposes to hide or conceal the sensing element 654 as mounted in its intended position about a structure. The partition 650 may also be functional in that it may facilitate mounting of the sensing element 654. The partition 650 may be located at any point between the contacting element 614 and the sensing element 654, and may comprise any size, configuration, color, etc. The partition 650 comprises apertures through which the transfer elements 694 may extend. However, the partition 650 is preferably configured to not interfere with the function of either the contacting element, the transfer elements or the sensing element.

FIG. 10-B further illustrates the sensing element 654 as comprising a protruded member 640 extending upward from the sensing element 654 about its perimeter. The protruded member is configured to support the partition 650 in an offset position so that no part of the partition 650 is allowed to contact the sensing element 654, which may skew the transfer of forces and/or any readings by the sensors, thus interfering with the accuracy of the projected force-based input device 610.

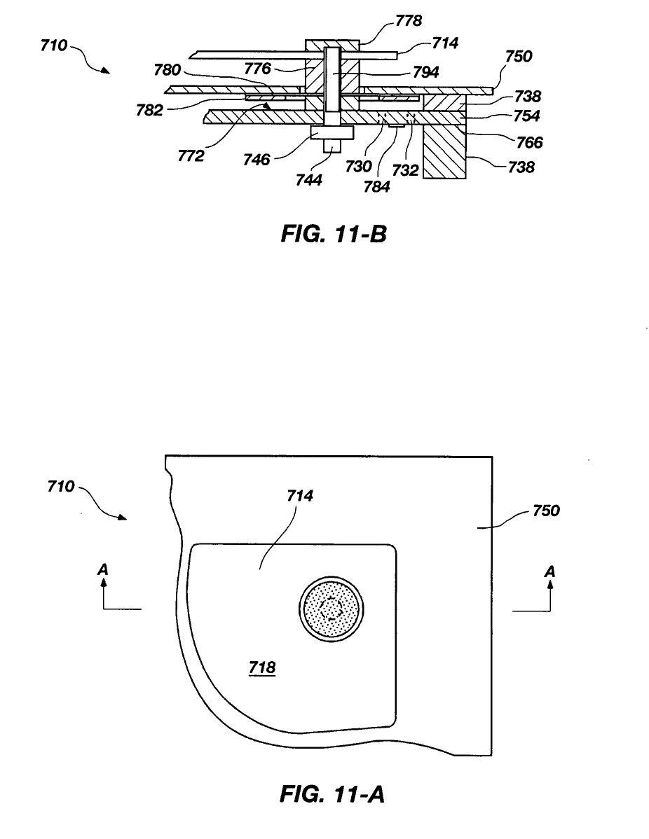

With reference to FIGS. 11-A and 11-B, shown is a projected force-based input device 710 in accordance with yet another exemplary embodiment of the present invention. In this embodiment, the projected force-based input device 710 comprises a floating design, wherein the components of the input device 710 are all supported in an elevated manner via a support 738 coupled to the mounting portion 766 of the sensing element 754. The mounting portion 766 extends around the perimeter of the sensing element 754, but may be located elsewhere on the sensing element 754. The support 738 further extends upward from the top surface of the sensing element 754 to operably support a trim plate 750.

The contacting element 714, with its upper contact surface 718, is located in a projected position and is operably related to the sensing element 754 via transfer elements (e.g., transfer element 794), which is secured within the sensing portion 772 of the sensing element 754 via a fastener 744 having a nut 746. In this particular embodiment, the transfer element 794 is concealed within a decorative shroud or cover 776 having a decorative cap 778. The contacting element 714 and sensing element 754 function in a similar manner as described elsewhere herein, wherein the sensors (e.g., sensor 784) are configured to measure the force as transferred by the transfer elements from the contacting element 714 to the sensing portion 772 of the sensing element 754.

The projected force-based input device 710 further comprises a gasket 780 retained by a retainer 782. The gasket 780 is positioned adjacent the underside of the trim plate 750 and is held in place against the trim plate 750 by a gasket retainer 782. The gasket 780 functions as a seal to ensure any moisture, rain, dust, dirt, other contaminants, etc. in the environment in which the input device is used is kept out of the interior of the input device where the sensors, the sensing portion, and the various electronics are supported. The gasket 780 may comprise a washer, and should be flexible enough so as to not absorb a significant amount of the applied force. Alternatively, all gaskets in a given design should be configured to absorb an equal percentage of the applied force.

FIGS. 12-A and 12-B illustrate a projected force-based input device 810 in accordance with still another exemplary embodiment of the present invention. In this particular embodiment, the construction and design of the various components of the input device 810 are similar to those described above and illustrated in FIGS. 10-A and 10-B, with some notable differences.

One difference between the exemplary input device 610 illustrated in FIGS. 12-A and 12-B as opposed to the exemplary input device 810 illustrated in FIGS. 10-A and 10-B is the elimination of the dedicated, separate transfer elements from the input device 810. Instead, the input device 810 comprises a protruded portion 840 integrally formed with the sensing element 854, which extends upward from the sensing element 854. In the embodiment shown, the protruded portion 840 is located about the perimeter of the sensing element 854, but this is not intended to be limiting in any way. The protruded portion 840 is configured to operably relate the contacting element 814 to the sensing element 854. In other words, the protruded portion 840 functions to transfer the forces applied to the contacting element 814 to the sensing element 854 much the same way the individual transfer elements do in other described embodiments. In this case, the forces are transferred to the outer portion of the sensing element 854. As such, the sensing portion 872 of the sensing element 854 is defined as that part of the sensing element 854 that is without or exterior to the apertures (e.g., apertures 830 and 832). In addition, the resultant location of the mounting portion 866 is interior to or within the apertures of the input device 810. Indeed, the mounting portion 866 is shown attached or coupled to the structure 838, which extends between each of the apertures of the input device 810.

The protruded portion may be comprised of the same or different material, but should be sufficiently stiff or rigid so as to effectively transfer the forces from the contacting element 814 to the sensing element 854, and to ensure proper operation of the input device as described above.

FIG. 13 illustrates projected force-based input device 910 as comprising a contacting element 914 operably related to a sensing element 954 in a projected manner, as supported by a transfer element 994. In this particular embodiment, the input device 910 is shown as passing through a partition 906, such as a wall, trim plate, etc., which may be functional (e.g., utilitarian) or nonfunctional (aesthetic) or both. The partition 906 may be formed or modified to receive the transfer elements 994 therethrough, thus allowing the contacting element 914 to still be projected from the sensing element 954, but also to maintain and conceal the sensing element 954 behind the partition 906.

If desired, or if needed, the partition 906 may be sealed with a sealing means, such as the rubber diaphragm 908 shown in FIG. 13. The sealing means may extend between the transfer element 994 and the partition 906, thus sealing the sensing element 954 from the environment in which the contacting element 914 is located. This may be advantageous for those applications in which the contacting element may be subjected to harsh or wet operating conditions, where it would be desirable to further protect the sensing element from such conditions. The sealing means may comprise other types and materials as commonly known in the art.

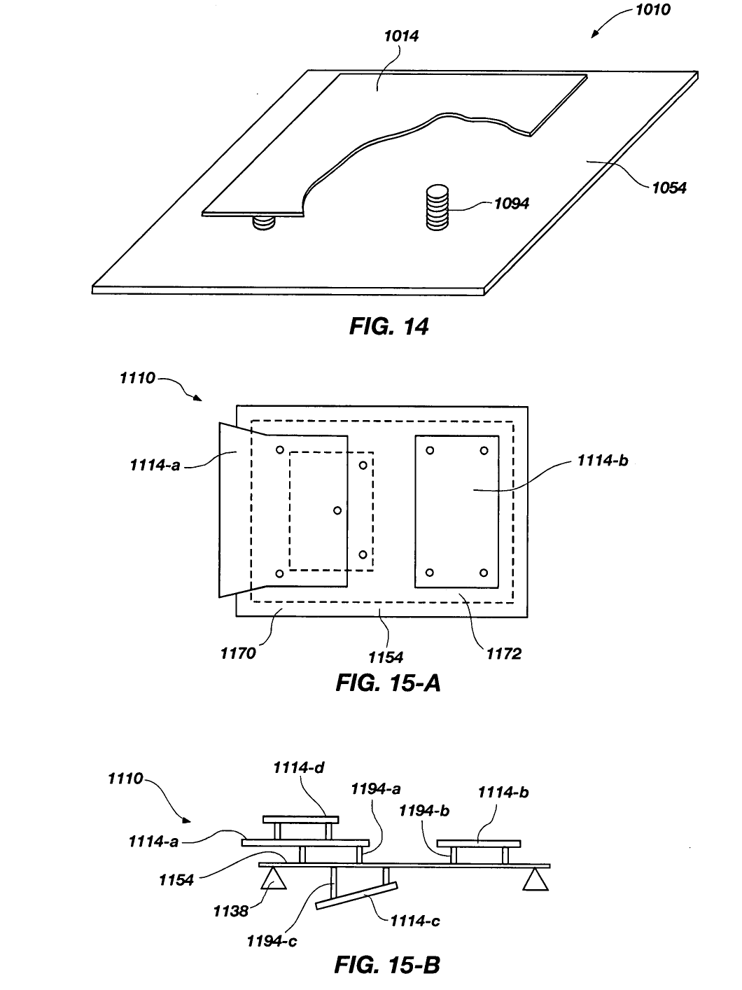

FIG. 14 illustrates a projected force-based input device in accordance with another exemplary embodiment of the present invention. As shown, the force-based input device 1010 comprises a contacting element 1014 supported in a projected manner and related to a sensing element 1054 in a similar manner as discussed herein. However, the transfer elements 1094 supporting the contacting element are comprised of compression springs, made from high aspect ratio rectangular wire so that they are not easily displaced or bent in the x-y direction, but are sufficiently rigid so as to transfer a force in the z-direction.

With reference to FIGS. 15-A and 15-B, illustrated is a projected force-based input device formed in accordance with still another exemplary embodiment of the present invention. As shown, the input device 1110 comprises a flat, planar sensing element 1154, and a plurality of individual elevated or projected contacting elements, shown as contacting elements 1114-a, 1114-b and 1114-c, each being connected by corresponding transfer elements, namely 1194-a, 1194-b and 1194-c, respectively. Also shown are sensors 1138 supported within the sensing element 1154, which sensors detect and measure forces applied to any one of the multiple contacting elements 1114.

This particular embodiment illustrates several different concepts at work within a single input device. First, multiple projected or elevated contacting elements are supported about and operable with a single sensing element, which multiple contacting elements are physically independent of one another. Second, projected or elevated contacting elements may be coupled to either side of the sensing element, with the input device operable to detect a force being applied to either of the contacting elements on either side of the sensing element. Third, multiple transfer elements are shown relating the multiple contacting elements to the sensing element, which multiple transfer elements are located at different locations. Fourth, the elevated contacting elements may be configured at different orientations with respect to one another and the sensing element. In addition, the transfer elements operable with the contacting elements may be of a different size.

Multiple elevated contacting elements supported on opposite sides of the same sensing element functions to generate inverse measurements. Indeed, a force applied on contacting element 1114-a will create a measurement that is inverse to the same force applied on the contacting element 1114-c. However, the inverse nature of the signals will be largely irrelevant with respect to processing the signals, determining the location and profile of the applied forces about the various contacting elements, and registering these locations to cause the input device to perform the intended functions.

FIG. 15-B further illustrates multiple contacting elements about one another. Specifically, input device 1110 comprises a contacting element 1114-d supported about the contacting element 1114-a. In this configuration, any forces applied to the contacting surface of the contacting element 1114-d are projected onto the sensing element 1154 via the transfer elements 1194-d, the contacting surface 1118-a, and the transfer elements 1194-a, just as if the applied force were occurring directly on the sensing element 1154. As such, the input device of the present invention may comprise multiple elevated or projected contacting elements supported about one another, keeping in mind that sufficient rigidity should be maintained to permit proper operation and force transfer.

With reference to FIG. 16, illustrated is a projected force-based input device in accordance with still another exemplary embodiment of the present invention. The input device 1210 comprises a flat, planar projected or elevated contacting element 1214 and a flat, planar sensing element 1254 configured as any of the sensing elements discusses herein. In this particular embodiment there are no transfer elements as the contacting element 1214 is supported directly about the sensing element 1254. The contacting element 1214 is sized and configured to fit within or to be contained within the sensing portion 1272 of the sensing element 1254 such that a force applied to any part of the contacting surface 1218 of the contacting element 1214 will register a force detectable by the sensing element 1254. In this configuration, any forces acting on the contacting element 1214 are transferred to the sensing element 1254 via the contacting element 1214. The overall effect is the same as if transfer elements were present. This particular embodiment may be useful in applications in which a more low-profile design is needed, or if it is not practical to use transfer elements. It is noted that the thickness of the contacting element 1214 may be any thickness.

Alternative to that shown, the contacting element may comprise a size and shape defining a perimeter that extends outside or beyond the sensing portion 1272. In this case, whatever mounting or other structures or objects are to be configured and positioned so as to not interfere with the contacting or sensing elements, similar to the other embodiments discussed herein.

FIG. 17 illustrates a projected force-based input device in accordance with still another exemplary embodiment of the present invention. In this configuration, the input device 1310 comprises a projected or elevated contacting element 1314 supported from a sensing element 1354 via transfer elements 1394. Unlike the other embodiments discussed herein, the sensing element 1354 is shown as having a cut-out portion 1320 formed therein to allow a force F₁ to be applied to a contacting surface 1318 of the contacting element 1314, which contacting surface 1318 is proximate the sensing element 1354 rather than distal. As such, the sensing element 1354 detects and registers a tension (−z) force rather than a compression (+z) force. However, this is accounted for by processing means operable with the input device to receive the signals output by the various sensors in the sensing element.

As indicated elsewhere herein, the input devices of the present invention may be configured to operate with forces acting on either side of the contacting element and the sensing element, or both. In other words, each of the contacting and sensing elements may be configured to receive an applied force from either side, which forces are detectable and measurable by the sensors supported within the sensing element. This is shown herein by the contacting element 1314 having forces F₁ and F₂ applied thereto on respective opposing sides or surfaces. The cut-out 1320 is illustrated in phantom view as it is conceivable that the sensing element 1354 may comprise multiple sensing elements not coupled together, but each operable within the same input device to support different portions of the elevated contacting element 1314.

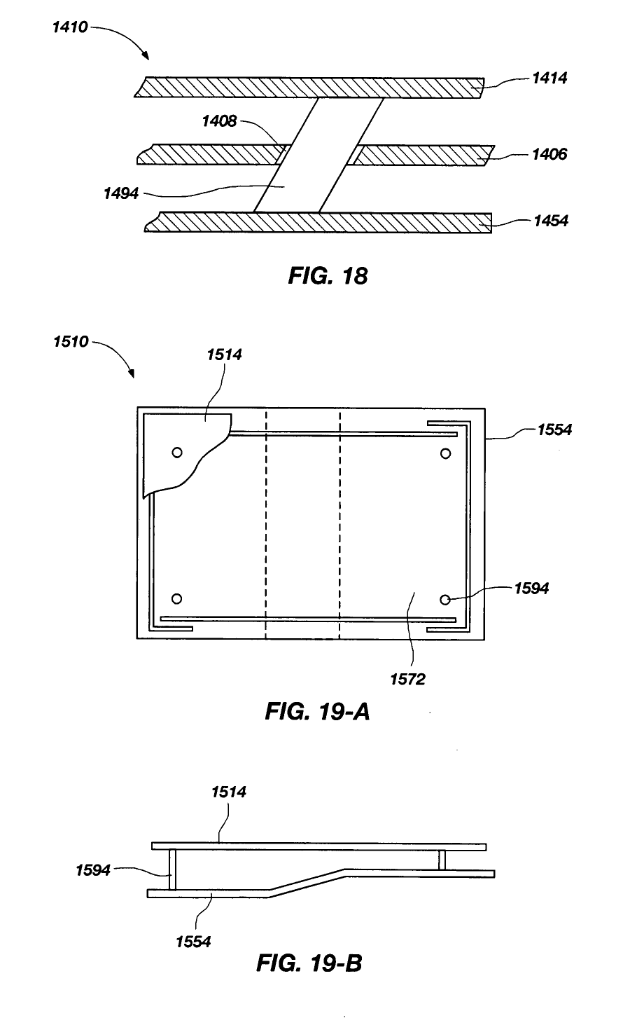

FIG. 18 illustrates another exemplary projected force-based input device 1410, wherein the transfer elements 1494 relating the sensing element 1454 to the elevated or projected contacting element 1414 are supported on an incline with respect to the contacting element 1414 or sensing element 1454 or both. This may be due to design constraints, such as a partition 1406 that requires transfer elements oriented other than perpendicular or orthogonal to the sensing or contacting elements. FIG. 18 further illustrates means for sealing the transfer element with respect to the partition 1406, which means for sealing is shown as comprising a rubber gasket 1408.

FIGS. 19-A and 19-B illustrate a projected input device 1510 formed in accordance with still another exemplary embodiment. In this embodiment, the input device 1510 comprises a projected or elevated contacting element 1514 supported about a sensing element 1554 having a non-planar, multi-elevational configuration. The sensing element 1554 comprises multiple sensors (not shown) that are operable to sense a force acting on the contacting element 1514 and transferred to the sensing portion 1572 of the sensing element 1554 via transfer elements 1594. The transfer elements 1594 are shown as comprising different sizes in order to support the projected or elevated contacting element 1514 in a horizontally oriented position, and to conform to the multiple elevations of the sensing element 1554. This embodiment illustrates that, similar to the contacting element, the sensing element may comprise a shape and configuration other than simply a flat, planar configuration. As the size of the transfer elements has no bearing on the transfer of forces from the contacting element to the sensing element, this particular input device embodiment functions similar to that shown in FIG. 1.

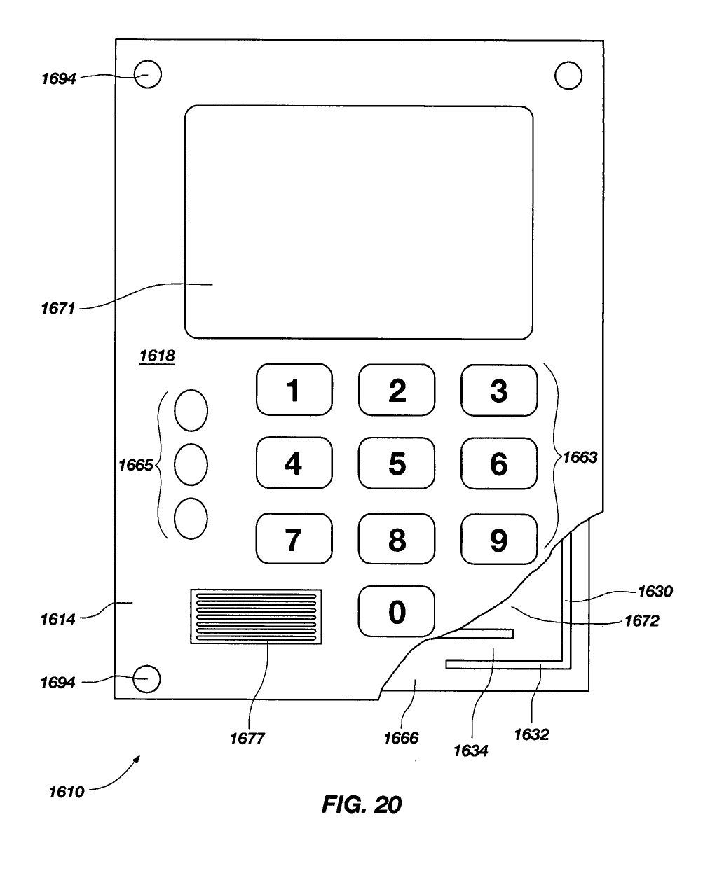

FIG. 20 illustrates a top view of a projected force-based input device 1610 having an exemplary user interface layout. It is noted that the layout may be configured in any way desired to provide many different types of user interfaces. In addition, the input device 1610 may be configured to function in any manner as set forth above with respect to any of the several embodiments discussed herein. Different user interfaces are described in copending U.S. Provisional Application No. 60/931,400, filed May 22, 2007, and entitled, “User Interfaces Operable with a Force-Based Input Device” (Attorney Docket No. 02089-32356.PROV, which is hereby incorporated by reference. Types of interfaces include, but are not limited to, tactile buttons, non-tactile buttons, visual paints or adhesives, removable objects, engravings, static attachments and/or dynamic attachments.

As shown, the contacting element 1614, or rather the upper contact surface 1618 of the contacting element 1614, comprises a plurality of delineated areas or regions, each having one or more identifying indicia, whereupon a force acting on the contacting element 1614 within any one of these regions would cause the input device 1610 to execute a pre-determined or designated function. More specifically, in the embodiment shown, the contacting element 1614 comprises a sort of keypad 1663 having a plurality of input regions or keys representing a plurality of numbers. It is noted that each of the various keys of the keypad 1663 are not mechanical buttons, but simply input areas to be touched that are delineated on the contacting element 1614. Each key is defined by its location on the contacting element 1614, such that when a touch occurs within that region or key the input device performs the desired function.

The contacting element 1614 may comprise any number of defined input regions or areas, such as the group of input regions 1665 that may be used to control one or more additional functions. These input regions are configured to receive a force, which forces are then transferred to the sensing portion 1672 of the sensing element 1654. The sensing portion 1672 is defined by the location of the various transfer elements 1694, the apertures 1630 and 1632 (which define the isolated beam segments, such as beam segment 1634), and the mounting portion 1666 (which in this case is an outer mounting portion extending around the perimeter of the sensing portion 1654).

The input device 1610 is shown as further comprising a display screen 1671 and a speaker 1677. These are designed to be operable with corresponding holes or cutouts (not shown, but existing) in the contacting element 1614. The display 1671 may be a separate device mounted to the underside of the contacting element 1614, or it may be integrally formed with the contacting element 1614 (e.g., glass or acrylic). As such, the display 1671 may also comprise any number of input regions that are configured to receive and register a touch or force input to cause the input device 1610 to perform a designated function. Indeed, with the display located within the sensing portion 1672 of the input device 1610, and with the display 1671 being coupled to or integrally formed with the contacting element 1614, the display is capable of comprising one or more defined input regions.

It is specifically noted herein that the contacting element 1614 comprises several holes or apertures formed in its surface. These are intended to provide the input device with added functionality. However, these holes or apertures have no affect on the operation of the input device. In other words, the contacting element in this or any of the other embodiments discussed herein may comprise various holes, cutouts, recesses, etc. formed in or about its surface that do not affect the other portions of the contacting element. Indeed, a touch or applied force at a given location on a contacting element with no holes or cutouts would register the same as a touch or applied force at a respective given location on a contacting element of the same size and configuration, except with one or more holes formed therein. To illustrate, with respect to the exemplary input device 1610 of FIG. 14, a force applied at the location on the contacting element delineated by the number 3 (the number 3 key) would register the same no matter if the contacting element 1614 had a cutout or not for a display 1671. In essence, an elevated or projected contacting element of the present invention may comprise any number of holes or cutout regions, without affecting the operation of the input device to detect forces applied about the actual surface regions of the contacting element.

It is noted herein that each of the above-described embodiments of input devices may comprise similar components and functions as any other embodiment, as applicable and recognized by those skilled in the art. Indeed, some components described specifically in some embodiments, and their functions, may operate with the input devices of other embodiments, as appropriate, and as will be recognized by those skilled in the art. As it was not necessary, each embodiment was not specifically set forth in complete detail, only how they differed from one another. However, each of the embodiments is based upon and comprises many of the same functions as the input device shown and described in FIGS. 1-5, which description is intended to be incorporated into each of the additional embodiments, as appropriate.

### Processing Means

As indicated above, the present invention projected force-based input device may comprise one or more sensors configured to output a data signal that may be used to facilitate the determination of a location and profile of the applied force about the contacting element. Based on this, it is contemplated that the present invention further comprises one or more processing means that may receive and utilize the data signals output by the sensors and perform various processing steps to determine the location or coordinates of the applied forces acting on the contacting element for one or more purposes.

The method for calculating the location, profile and/or magnitude of an applied force acting on the contacting element is the same as for an input device having a non-projected contacting element. Any amplification of the x-y forces induced by the projected distance is inherently minimized by the sensing portion, and what is not minimized is inherently read by the sensors and induces some error in the x-y position just as an off-axis force on the non-projected contacting element is minimized by the sensing portion. Again, the location, number, size and methods of construction of the transfer elements have no effect on the calculation of the applied force location, as long as the input device is sufficiently rigid. In addition, the projection distance has no effect on the method of calculation of the applied force location, although, as noted above, this may affect the overall accuracy of the applied force location if the flexibility of the transfer elements is capable of permitting interference of either the contacting or sensing element with one or more structures or objects.

Exemplary techniques for processing signals from the sensors are also disclosed in commonly owned co-pending U.S. patent application Ser. No. 11/402,985, filed Apr. 11, 2006, and entitled “Sensor Signal Conditioning in a Force-Based Input Device” (attorney docket 24415.NP1), and U.S. patent application Ser. No. 11/402,692, filed Apr. 11, 2006, and entitled “Sensor Baseline Compensation in a Force-Based Touch Device” (attorney docket 24415.NP2), each of which are incorporated herein by reference in their entirety.

Indeed, other processing means and methods may be employed by the present invention that are known to those skilled in the art. For example, U.S. Pat. Nos. 4,121,049 to Roeber; and 4,340,772 to DeCosta et al. disclose and discuss exemplary processing methods. As such, the present invention should not be limited to any particular processing means or methods, as each of these is contemplated for use and may be implemented with the force-based touch pad of the present invention to perform its intended function of processing the signal(s) received from the various sensors for one or more purposes.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A projected force-based input device comprising:
a sensing element having a mounting portion and a sensing portion operable to detect and measure an applied force;
a plurality of force sensors operable within said sensing portion to measure a resultant characteristic of said applied force, and to output sensor data corresponding to said resultant characteristic;
a contacting element elevated at least partially from said sensing element and having a contacting surface operable to initially receive said applied force;
means for projecting substantially all of said applied force from said contacting element to said sensing portion of said sensing element to cause said resultant characteristic be detected and measured by said sensors as if said applied force were acting directly on said sensing element; and
processing means operable to receive and process said sensor data, and to determine a location or other characteristic of said applied force as acting on said contacting surface of said contacting element.

2. The projected force-based input device of claim 1, wherein said means for projecting comprises a force transfer element configured to relate said contacting element to said sensing portion, and to position these in a spaced apart configuration.

3. The projected force-based input device of claim 1 or 2, wherein said sensing element, said contacting element and, optionally, said force transfer element are assembled with sufficient rigidity so as to prevent interference of either of said contacting and sensing elements and said force transfer element with a mounting object.

4. The projected force-based input device of claim 1, wherein said means for projecting comprises said contacting element and said sensing element being in direct contact with one another such that said applied force is transferred from said contacting element directly to said sensing element.

5. The projected force-based input device of claim 1, wherein said sensing element comprises:
a base support having a mounted periphery and a plurality of apertures formed near said periphery to define said periphery and said sensing portion, said sensing portion being operable to displace under said applied force acting on said contacting element as transferred to said sensing portion; and
a plurality of isolated beam segments defined by said plurality of apertures and operable to receive resultant forces distributed to said isolated beam segments by the displacement of said sensing portion.

6. The projected force-based input device of claim 5, wherein said force sensors are operable with said isolated beam segments to measure a resultant characteristic of said applied force in the form of strain acting within a respective isolated beam segment, said strain occurring as a result of various stresses being induced within said isolated beam segment as a result of said projection of said applied forces to said sensing portion.

7. The projected force-based input device of claim 1, wherein said sensing element comprises:
a first structural element supported in a fixed position;
a second structural element operable with said first structural element, and dynamically supported to be movable with respect to said first structural element to define a sensing portion configured to displace under said applied force as transferred to said sensing portion; and
a plurality of isolated beam segments joining said first and second structural elements, said isolated beam segments being operable to transfer forces between said first and second structural elements, and to receive resultant forces distributed to said isolated beam segments upon displacement of said sensing portion.

8. The projected force-based input device of claim 7, wherein said first structural element comprises an outer mounting portion, and said second structural element comprises said sensing portion as circumscribed by said outer mounting portion and optionally an inner mounting portion.

9. The projected force-based input device of claim 7, wherein said first structural element comprises an inner mounting portion, and said second structural element comprises said sensing portion as positioned about said periphery of said sensing element, wherein said inner mounting portion is circumscribed by said sensing portion.

10. The projected force-based input device of claim 1, wherein said sensing element comprises a non-planar, multi-elevational configuration.

11. The projected force-based input device of claim 1, wherein said sensing element comprises at least one cut-out portion.

12. The projected force-based input device of claim 1, wherein said sensing and contacting elements are each able to receive an applied force.

13. The projected force-based input device of claim 1, further comprising a plurality of contacting elements operable with said sensing element, wherein each of said plurality of contacting elements is capable of receiving an applied force subsequently projected to said sensing element.

14. The projected force-based input device of claim 1, wherein said contacting element comprises a configuration selected from the group consisting of a non-planar, multi-elevational configuration, a flat, planar configuration, an arbitrarily shaped geometric configuration, a standard geometric configuration, and any combination of these.

15. The projected force-based input device of claim 1, wherein said contacting element comprises portions located at different elevational distances from said sensing element.

16. The projected force-based input device of claim 1, wherein said contacting element is formed of multiple different materials, each one operating to provide a functional contacting surface.

17. The projected force-based input device of claim 1, wherein said contacting element comprises at least one cut-out portion.

18. The projected force-based input device of claim 1, wherein said contacting element comprises a periphery that at least partially extends beyond an x-y boundary of said force sensors, said force sensors measuring inverse measurements caused by different applied forces acting on said contacting element within and without said x-y boundary.

19. The projected force-based input device of claim 1, wherein said contacting element is oriented on an incline or in a non-parallel position with respect to said sensing element.

20. The projected force-based input device of claim 1, wherein said contacting element comprises multiple contacting surfaces, each one operable to receive an applied force for subsequent projection to said sensing element.

21. The projected force-based input device of claim 20, wherein said multiple contacting surfaces are oriented so as to face in opposing directions.

22. The projected force-based input device of claim 2, wherein said force transfer element comprises different sizes to accommodate various multi-elevational configurations of at least one of said contacting and sensing elements.

23. The projected force-based input device of claim 2, wherein said force transfer element comprises a protruding member formed from said sensing element.

24. The projected force-based input device of claim 2, wherein said force transfer element is mounted to said sensing and contacting elements using one or more fastening means.

25. The projected force-based input device of claim 2, wherein said force transfer element comprises a structural configuration selected from the group consisting of a solid structure and a structure having a hollow interior, each one of these being sufficiently rigid so as to facilitate proper transfer of said applied force from said contacting element to said sensing element.

26. The projected force-based input device of claim 2, wherein said force transfer element comprises a spring having a spring constant of sufficient stiffness so as to facilitate proper transfer of said applied force from said contacting element to said sensing element.

27. The projected force-based input device of claim 2, wherein said force transfer element is oriented on an incline with respect to said sensing and contacting elements.

28. The projected force-based input device of claim 1, further comprising lighting means positioned about at least one of said contacting and sensing elements, said lighting means providing one or more lighting functions to said input device.

29. The projected force-based input device of claim 28, wherein said lighting means is disposed between said contacting element and said sensing element.

30. The projected force-based input device of claim 1, further comprising a partition disposed between said contacting element and said sensing element, said partition operating with said contacting and sensing elements, and any force transfer elements, to conceal said sensing element, and to provide one or more aesthetic or utility functions to said input device.

31. The projected force-based input device of claim 30, wherein said at least a fixed part of said sensing element is mountable to said partition for support.

32. The projected force-based input device of claim 1, further comprising one or more user interface objects supported about at least one of said contacting and sensing elements, said user interface object providing one or more interface functions.

33. A projected force-based input device comprising:
a contact plane having a contact surface for receiving an applied force;
a sensing plane offset from said contact plane, and comprising a sensing element having a sensing portion;
a plurality of sensors operable within said sensing portion to output sensor data corresponding to said applied force, wherein said sensor data facilitates the determination of a location or other characteristic of said applied force as occurring about said contact plane; and
at least one force transfer element that transfers substantially all of said applied force occurring about said contact plane to said sensing portion of said sensing plane.

34. The projected force-based input device of claim 33, wherein said contact plane is parallel to said sensing plane.

35. The projected force-based input device of claim 33, wherein said contact plane is oriented on an incline with respect to said sensing plane.

36. A projected force-based input device comprising:
a contacting element contained within a contact plane, and having a contacting surface configured to receive an applied force;
a sensing element contained within a sensing plane, and having a plurality of sensors operable therewith to output sensor data corresponding to said applied force, wherein said sensor data facilitates the determination of a location or other characteristic of said applied force about said contacting element; and
a transfer element configured to project said contacting plane away from said sensing plane, and to transfer substantially all of said applied force from said contacting element to said sensing element.

37. Within a projected force-based input device, a method for determining a location or other characteristic of an applied force and for performing one or more operations, said method comprising:
receiving an applied force about a contacting surface of an elevated contacting element;
transferring said applied force to a sensing portion of a sensing element supported in a different elevation with respect to said contacting element, said sensing element having a plurality of sensors operable to output sensor data corresponding to said applied force;
measuring a characteristic of said applied force;
generating sensor data based on said measured characteristic; and
processing said sensor data to determine a location or other characteristic of said applied force occurring about said contacting element.

38. The method of claim 37, further comprising executing a command causing said input device to perform an intended operation upon receiving said applied force and determining said location or other characteristic of said applied force about said contacting element.

39. A method for constructing a projected force-based input device, said method comprising:
providing a sensing element having a mounting portion and a sensing portion operable to detect an applied force;
securing said mounting portion of said sensing element;
supporting said sensing portion of said sensing element so as to be movable with respect to said mounting portion;
providing a plurality of force sensors operable within said sensing portion to measure a resultant characteristic of said applied force, and to output sensor data corresponding to said resultant characteristic;
positioning a contacting element in a different elevation with respect to said sensing element, said contacting element having a contacting surface operable to initially receive said applied force;
relating said sensing element to said contacting element with sufficient rigidity so as to effectuate transfer of substantially all of said applied force from said contacting element to said sensing element, said contacting element projecting substantially all of said applied force to said sensing portion of said sensing element to cause said resultant characteristic be detected and measured by said sensors as if said applied force were occurring directly about said sensing element; and
providing processing means operable to receive and process said sensor data, and to determine a location or other characteristic of said applied force as acting on said contacting surface of said contacting element.

40. The method of claim 39, further comprising concealing said sensing element behind a partition, said partition being disposed between said contacting element and said sensing element.

41. The method of claim 40, further comprising sealing said partition with respect to at least one component of said input device.
